(19) United States
(12) Patent Application Publication
(10) Pub. No.: US 2021/0081974 A1
(43) Pub. Date: Mar. 18, 2021

(54) JOB QUALITY INDEX SYSTEM

(71) Applicant: JQI IP Holdings LLC, Sheffield, MA (US)

(72) Inventors: Daniel ALPERT, Sheffield, MA (US); Jeffrey FERRY, Sheffield, MA (US); Robert C. HOCKETT, Sheffield, MA (US); Amir KHALEGHI, Sheffield, MA (US); Michael STUMO, Sheffield, MA (US)

(73) Assignee: JQI IP Holdings LLC, Sheffield, MA (US)

(21) Appl. No.: 17/022,741

(22) Filed: Sep. 16, 2020

Related U.S. Application Data
(60) Provisional application No. 62/900,923, filed on Sep. 16, 2019.

(51) Int. Cl. G06Q 30/02; G06F 16/953

(52) U.S. Cl. CPC G06Q 30/0203; G06Q 40/04; G06F 16/953

(57) ABSTRACT

A system for generating a job quality index (JQI) that represents quality of U.S. jobs includes a non-transitory computer readable medium and a processor. The processor sends a query, over a network, to a remote data server to retrieve monthly current employment survey (CES) data. A high-quality benchmark is determined by computing a weighted average in weekly wages for each of a plurality of industries based on the CES data. The processor determines a first total count of high-quality jobs and a first total count of low-quality jobs based on a comparison between an average weekly wage of each industry and the high-quality benchmark. A JQI is calculated by dividing the first total count of high-quality jobs by the first total count of low-quality jobs.

### CROSS REFERENCE TO RELATED APPLICATION

The present application claims benefit of U.S. Provisional Patent Application No. 62/900,923 filed Sep. 16, 2019. The entire contents of which are hereby incorporated by reference.

### FIELD

The presently disclosed subject matter relates generally to computer platforms for managing and/or utilizing large data sets on select economic data to extract key performance parameters; and more specifically to a computer platform that processes select data to provide insights on national market conditions including a novel job quality index system, and the processing systems and methods for generating a job quality index that represents and tracks the quality of U.S. jobs.

### BACKGROUND

The dimension and composition of the U.S. labor force have changed substantially over the past quarter century, with the number of positions below the mean level of weekly wages (weekly hours worked, multiplied by hourly wages) increasing materially from the 1990s through the present decade. While the percentage of private U.S. jobs in the service providing sectors increased steadily from about 55%, during the years immediately following the end of World War II through 2009, the end of the Great Recession, that percentage has remained flat, at around 83.5% since that point. Yet despite the leveling off of service sector growth as a percentage of all jobs, the quality of those jobs continues to worsen.

Other broad factors that may underpin the deterioration in relative job quality in the U.S. Among these factors are (i) a greater dependence on labor, as opposed to capital investment, to address upswings in the business cycle given that the Great Recession, and other economic circumstances, having reduced business confidence necessary to engage in expansion of plants and acquisition of new equipment; (ii) the advent of “just-in-time” labor practices, featuring the scheduling workers' shifts with little advance notice, that are subject to cancelation hours before they are due to begin; and (iii) the existence of exogenous sources of labor—especially in the goods producing and high-value-added service sectors (intellectual property creation, financial services and communications/information services sectors) to which production can be shifted as demand and costs dictate.

Unfortunately, the reporting of employment data by the U.S. government and other entities providing analytics, is not well suited to the consideration of the quality of America's employment base. Furthermore, the focus of business economists and the media on headline job counts and unemployment rates encourages the dissemination and broadcast of an employment situation “story” that is incomplete and, often, inaccurate in its assessment of the well-being of same. Yet the data necessary to report on the quality-related health of the U.S. jobs base exists in large part and has been materially improved upon since 1990, when the U.S. Bureau of Labor Statistics (BLS) broadened the sectoral analysis on which it reports monthly. The BLS again expanded its reporting in 2000, when it moved to monthly reporting of such data for all employees, as opposed to its traditional monthly wages and hours data reporting only for production and non-supervisory (P&NS) workers.

The national employment situation—at least in the U.S.—is scrutinized with little regard to the growing differences among jobs. For example, while the BLS Current Employment Statistics (CES) covers approximately 180 distinct job categories in fairly minute detail—politicians, policy makers, market participants, and even those among the general population caring enough to pay attention, focus mostly on the number of employed persons relative to the size of the labor force; the numbers of jobs being created or being lost; and average hourly wages paid to employees; and the number of hours worked by same each week.

Yet, despite substantial decreases in the rate of unemployment and the creation of a large number of new jobs—seen in the U.S., and other advanced nations, in recent years—improvement in hourly wages and worker incomes have been lackluster and there has been only a small recovery in the U.S. post-Great Recession labor force participation rate—from a seasonally-adjusted low of 62.4% in September 2015, to 63.2% in August 2019 (the same level as January 2019, with some erosion/recovery in between)—relative to its level of 66% on the eve of the recession and 67% in 1999. These contrasting phenomena suggest that something more ominous is plaguing the U.S. employment situation.

The problem is that many observers of U.S. employment have generally failed to recognize the relative quality of the overall pool of existing jobs in the country, and how that has changed over time. The history of private sector employment in the United States over the past three decades is one of overall degradation in the ability of many American jobs to adequately support households—even those households with multiple jobholders. Part of the reason for this is that the U.S. has, over that period, become more dependent on jobs that offer fewer hours of work at lower relative wages. The key observation is the dynamics between the two forgoing factors.

In view of the foregoing, there is a need for a system to assess—on a periodic (monthly) basis—the degree to which the number of jobs in the United States are weighted towards more desirable higher-wage/higher-hour jobs versus lower-wage/lower-hour jobs, as a proxy for the overall health of the U.S. jobs market.

There is a need for a system to (i) quantify the observable increased dependence of U.S. workers on low-wage/low-hour jobs over the past quarter century, and (ii) enable the month-by-month tracking in the direction and degree of change in index to better inform policy makers and financial market participants.

There is a need for a system to determine and present the distribution of U.S. jobs, as between lower-wage/lower-hours positions and higher-wage/higher-hours positions, and determine and present this change over time. There is a need for a system to determine and present the trajectory of weekly pay (hourly wages times hours worked), and the relationship between the trajectories of two cohorts.

There is a need for a system to determine and present to what extent the increase in lower-wage/lower-hours positions, relative to higher-wage/higher-hours positions, stems from the emergence of the so-called “gig” economy in which multiple positions are held by individual workers. There is a need for a system to determine and present the relationship between hours worked and hourly wages, and determine and present what portion of the failure of lower quality jobs to adequately provide decent livings for many workers rests with each of these factors. There is a need for a system to determine and present the relationship between global trade and the adverse changes in job quality in the United States. There is a need for a system to determine and present, within the cohorts of lower-wage/lower-hours jobs and higher-wage/higher-hours jobs, how the constituent positions have changed over time and what that tells us about the industrial investment and development. There is a need for a system to determine and present whether the U.S., as a practical matter, maximized service sector employment as a percentage of total jobs, and what that means for future wages growth in the services sector. There is a need for a jobs-related index that offers the ability to observe intertemporal changes in the make-up of the U.S. employment base together with the capacity for real time updates reflecting new monthly data. Embodiments of the present disclosure are directed to this and other considerations.

### SUMMARY

Aspects of the disclosed technology include systems and methods for generating a Job Quality Index (JQI) to assess the degree to which the number of jobs in the United States are weighted towards desirable higher-wage/higher-hour jobs versus lower-wage/lower-hour jobs, as a proxy for the overall health of the U.S. jobs market. The JQI (i) demonstrates the overall increased dependence of U.S. workers on low-wage/low-hour jobs over the past quarter century, and (ii) enables the month-by-month tracking in the direction and degree of change in index to better inform policy makers and financial market participants.

Aspects of the disclosed technology include systems and methods for generating a job quality index (JQI) that represents quality of U.S. jobs. Consistent with the disclosed embodiments, the system includes a non-transitory computer readable medium and a processor. The processor sends a query, over a network, to a remote data server to retrieve monthly current employment survey (CES) data. The retrieved CES data is stored in the non-transitory computer readable medium. The processor calculates a high-quality benchmark by calculating a weighted average in weekly wages for each of a plurality of industries based on the CES data. The processor determines a first total count of high-quality jobs and a first total count of low-quality jobs based on a comparison between an average weekly wage of each industry and the high-quality benchmark. The processor calculates a preliminary JQI by dividing the first total count of high-quality jobs by the first total count of low-quality jobs. The calculated preliminary JQI is output for display, over the network, on a user device.

Another aspect of the disclosed technology relates to a system for generating a JQI that represents quality of U.S. jobs. The system includes a non-transitory computer readable medium and processor. The processor sends a first query, in real time, over a network, to a remote data server to retrieve monthly current employment survey (CES) data. The processor calculates a high-quality benchmark by calculating a weighted average in weekly wages for each of a plurality of industries based on the CES data. The processor determines a first total count of high-quality jobs and a first total count of low-quality jobs based on a comparison between an average weekly wage of each industry and the high-quality benchmark. The processor calculates a preliminary JQI by dividing the first total count of high-quality jobs by the first total count of low-quality jobs. The processor sends a second query, in real time, to the remote data server to retrieve annual occupational employment statistics survey data. The processor filters the annual occupational employment statistics survey data to include major occupations within each industry. The processor identifies a flip category of industries from the filtered annual occupational employment statistic survey data, wherein each industry in the flip category has a high propensity of flipping above and below the high-quality benchmark, and wherein each industry in the flip category has at least one million employees. The processor collects annual wage data from the filtered annual occupational employment statistics survey data for each occupation in the flip category. The processor converts the collected annual wage data into weekly wage for each occupation. The processor calculates a second high-quality benchmark by determining a monthly average of the high-quality benchmark of twelve months. The processor compares the converted weekly wage to the second high-quality benchmark. The processor determines a second total count of high-quality jobs and a second total count of low-quality jobs within the flip category based on a comparison between the converted weekly wage and the high-quality benchmark. The processor calculates a percentage of high-quality jobs for each flip category by dividing the second total count of high-quality jobs by a total number of jobs. The processor multiplies the calculated percentage of high-quality by employment data provided by the CES data for each flip category to determine a third total count of high-quality jobs. The processor determines a third total count of low-quality jobs based on the employment data provided by the CES data for each flip category and the third total count of high-quality jobs. For each flip category, the processor adjusts the preliminary JQI based on the third total count of high-quality jobs and the third total count of high-quality jobs to derive an adjusted JQI. The processor automatically transmits, over the network, to the user device, the calculated adjusted JQI.

In one embodiment, the processor compares the calculated adjusted JQI to a predetermined threshold, automatically generates an alert based on a comparison between the calculated adjusted JQI and the predetermined threshold, and transmits the generated alert to the user device.

In one embodiment, the processor determines a moving average of the calculated adjusted JQI over a predetermined period of time.

In one embodiment, the processor identifies a correlation between the determined moving average and financial data provided by an external database, and generates an alert to the user device reporting the identified correlation.

In one embodiment, the processor detects a change of the determined moving average of the calculated adjusted JQI, and automatically generates an alert to the user device reporting the detected change, wherein the detected change meets a trigger threshold.

In one embodiment, the processor automatically generates a diagram illustrating the calculated adjusted JQI relative to financial data provided by an external database.

In one embodiment, the processor automatically transmits the calculated adjusted JQI to a trading platform of futures market to price securities and permit trading.

Further features of the present disclosure, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, explain the principles of the disclosed technology. In the drawings:

FIG. 1 is an example block diagram illustrating communications among a JQI system, a BLS data server and a user device according to one aspect of the disclosed technology.

FIG. 2 provides explanations for variables.

FIG. 3 illustrates example flip categories.

FIG. 4 illustrates an example diagram for calculating JQI.

FIG. 5 illustrates an example flowchart for calculating JQI.

FIG. 6 is an example flow chart of a process performed by the JQI system according to one aspect of the disclosed technology.

FIG. 7 illustrates an example report interface with filters.

FIG. 8 illustrates an example report result with no filters applied.

FIG. 9 illustrates a diagram illustrating 3-month lagged JQI versus 10-year treasury constant maturity rate.

FIG. 10 illustrates a diagram representing composition of P&NS jobs at January 1990.

FIG. 11 illustrates a diagram representing net P&NS job formation since January 1990.

FIG. 12 illustrates a diagram representing inflation adjusted weekly income for high- and low-quality jobs.

FIG. 13 illustrates a diagram representing the private sector job quality index.

FIG. 14 illustrates a diagram representing JQI spike in 2016/2017 relative to change in employment in U.S. construction and manufacturing and industrial production.

FIG. 15 illustrates a diagram representing U.S. trade deficit versus JQI over time.

FIG. 16 illustrates a diagram representing U.S. trade deficit in goods versus job quality index over time.

FIG. 17 illustrates a diagram representing U.S. trade deficit in good ex-petroleum versus job quality index over time.

FIG. 18 illustrates a diagram representing manufacturing labor productivity and capacity utilization over time.

FIG. 19 illustrates a diagram representing deterioration in JQI and relative fixed income investment in structures and non-information processing equipment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

1. Technology

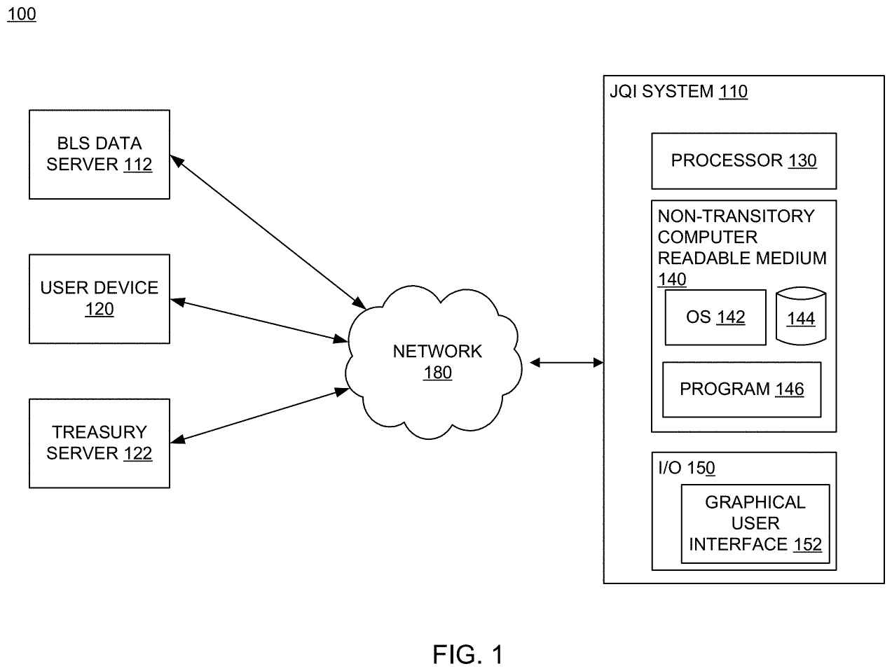

FIG. 1 shows an example environment 100 that may implement certain aspects of the present disclosure. The components and arrangements shown in FIG. 1 are not intended to limit the disclosed embodiments as the components used to implement the disclosed processes and features may vary. As shown in FIG. 1, in some implementations the environment 100 may include one or more of the following: one or more JQI systems 110, one or more BLS data servers 112, one or more user devices 120, and one or more networks 180.

The JQI system 110 may generate a JQI based on data on private sector (non-governmental) jobs provided by third party employers. The JQI may not track workers in positions of self-employment. The JQI system 110 may present a graphical user interface 152 on one or more user devices 120, through which a user may interact with the JQI system 110. For example, the user may select or query a specific industry through the graphical user interface 152. The JQI system 110 may automatically generate the JQI for the user selected industry. The JQI may automatically generate one or more diagrams, and display the diagrams in the graphical user interface 152.

The JQI may be defined by the basic metric of the weekly dollar income a job generates for an employee. The term quality may refer to weekly pay, which is for many people the primary reason they work and indeed essential to maintain their standard of living, feed their family, and save for emergencies, retirement, and so on. Employment is the primary driver of aggregate demand in an economy led so greatly by consumption as that of the United States. The JQI may serve as a leading, rather than lagging, indicator of fluctuations in such demand and of the performance of many other aspects of the economy and financial markets.

The JQI generated by the JQI system 110 may be essentially an analysis of weekly incomes earned by the holders of each of the private sector P&NS jobs in the U.S. To generate the JQI, the JQI system 110 may derive data from the hourly wages paid and hours worked by holders of jobs in many separate sectors, such as 180 separate sectors. Some of those sectors—due to large size and statistical relevance, being close to the mean weekly income levels of all private sector P&NS jobs—may be further broken down to allocate positions into sub-groups reflecting wage data derived from the BLS Occupational Employment Statistics Survey (OES), which allocation is to be updated annually following the release of the OES. The forgoing allocation may effectively result in the creation of subsectors providing for even more granularity of inputs.

To generate the JQI, the JQI system 110 may divide all the categories of jobs in the U.S. into high and low quality by calculating the mean weekly income (hourly wages times hours worked) of all P&NS jobs, and then calculate the number of P&NS jobs that are above or below that mean. A calculated JQI reading of 100 may indicate an even distribution, as between high- and low-quality jobs. Readings below 100 may indicate a greater concentration in or reliance on lower quality (those below the mean) positions. A reading above 100 may mean the opposite.

The JQI system 110 may generate the JQI in real time, such that the JQI is a real-time reading on the forgoing measure of quality of U.S. jobs. The JQI system 110 may recalculate the JQI and generate a report or alert that releases the recalculated JQI. The report or alert may be released on the same day as the release of the U.S. Employment Situation report by the BLS, such as at the beginning of each month with reference to the month prior, and adjustments to the two preceding months. The JQI system 110 may perform annual revisions in June of each year on the JQI to incorporate annual changes in subsector wage cohorts reported in the Occupational Employment Statistics Survey revisions in May of each year.

The JQI may provide a real-time alternative measure of the U.S. employment situation that may be significantly more predictive of near-term labor slack or shortages, wage pressure or its absence, per-household income and demand and, to an extent, overall economic growth—than are job formation, the unemployment rate or hourly wage growth on their own. Unlike the latter three conventional measures, the JQI may have the capacity to highlight the level of “effective underemployment” of the labor force that is dependent on the type and mix of jobs available.

The JQI may analyze a representative sample of the economy using P&NS data from 180 different industry groups spanning across all 20 super sectors. The principal data utilized may be contained in the CES (also may be referred to as the establishment survey), P&NS data on average weekly hours (AWH), average hourly wage (AWH), and total employment for each given industry group (seasonally adjusted, in all cases). The JQI may be recalculated on a monthly basis contemporaneously with the release of new CES data from the Bureau of Labor Statistics. The BLS consistently maintains the CES on a monthly basis and has done so, in some version of its current form since 1990 (previously, from 1938 to 1989, the establishment survey was considerably less granular.

Employment may represent the total number of persons on an establishment's payroll employed full or part time who received pay, regardless of working or not, for any pay period that includes the 12th day of the month. Persons on the payroll of more than one establishment may be counted in each establishment.

With nearly 30 years of available CES data, in its present form, covering P&NS jobs, the JQI may represent a real-time alternative measure of the U.S. employment situation that would have previously been difficult to fabricate. The JQI may be significantly more predictive and informative, relative to conventional measures, with regard to levels of underemployment and labor force slack.

The process for creating the JQI may begin with establishing a Quality Job Benchmark by a processor 130 of the JQI system 110 for each given month. The benchmark value may be indicated by the average weighted weekly wage within the set of 180 industry groups, weighted for the number of jobs in each group. Once the benchmark is established for that given month, the processor 130 may sort each industry group into low or high quality by comparing each group's specific weekly wage to the quality benchmark. If an industry's weekly wage for the month is below (above) the benchmark, then it is considered low (high)-quality job. Once sorted, the processor 130 may then divide the total number of high-quality jobs by low quality jobs for that given month. This ratio may represent the preliminary JQI value. A JQI reading of 100 may indicate an even distribution. Readings below 100 may indicate a greater concentration in/reliance on lower quality (those below the mean) positions. A reading above 100 may mean the opposite. The total number of “jobs” may be represented by the total number of employees for that given industry group.

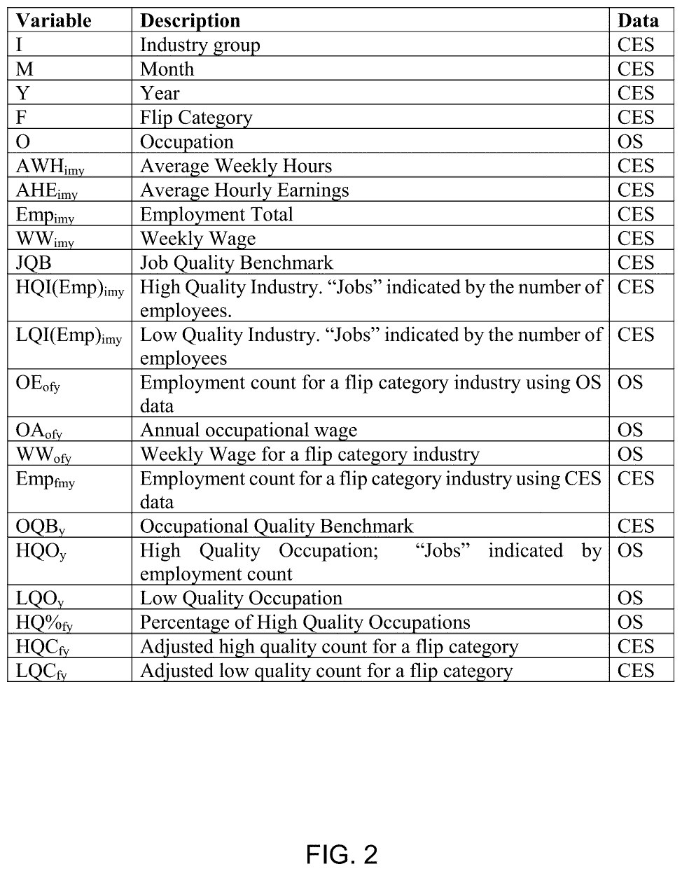

In one embodiment, the processor 130 of the JQI system 110 may calculate a preliminary JQI and an adjusted JQI. To calculate the preliminary JQI measure, each industry(i) may contain a unique series ID. FIG. 2 provides explanations for variables described herein.
Series ID (Logging)=CES1011330006=Logging=i₁
Series ID (Oil and Gas Extraction)=CES1021100006=i₂
Series ID(X)=CESxxxxxxxxxx=iₓ
Industry=i={1, 2, 3, . . . , 180}

Each point in time may be noted by the date. (mm/yy)
Month=m={01, 02, 03 . . . , 12}
Year=y={1, 2, 3 . . . , 29}

The JQI system 110 may implement the following algorithms to calculate the high-quality benchmark. The weekly wage may be calculated as follows.

WW(CES)_{imy}=(AWH_{imy}*AHE_{imy})

The processor 130 may find a weighted average weekly wage for entire industry group.

$$J Q {B ( C E S )}_{i m y} = \frac{Σ ( W {W ( C E S )}_{i m y} )}{Σ ( E m {p}_{i m y} )}$$

The JQI system 110 may determine a total number of high quality and a total number of low-quality jobs. Industry may be high quality if its weekly wage is greater than the job quality benchmark.

WW(CES)_{imy}>JQB(CES)_{imy}∴HQI

The job count for a high-quality industry may be indicated by the employment number.

High Quality Industry=HQI_{imy}=HQI(Emp)_{imy}

Industry may be low quality if its weekly wage is less than the job quality benchmark.

WW_{imy}<HQB(CES)_{imy}∴LQI

The job count for a low-quality industry may be indicated by the employment number.

Low Quality Industry=LQI_{imy}=LQI(Emp)_{imy}

The processor 130 may calculate the preliminary JQI measure as follows:

$$Pre \text{-} J Q {I}_{my} = \frac{Σ HQI ( {Emp}_{imy} )}{Σ LQI ( {Emp}_{imy} )}$$

The preliminary JQI measure may be then further adjusted in the case of certain industries that generate weekly wages at or near the quality benchmark and contain a sufficient number of jobs such that minor movements in weekly wages would have the effect of “flipping” them from one side of the quality benchmark to the other from month to month, thereby resulting in unintended statistical noise that can be easily remedied. In the case of such “flip categories” of industry groups in which a large number of employees can potentially flit from low to high quality and vice versa, the processor 130 may utilize additional data to further divide such industry groups into sub-groups.

As an example of such a flip category, for example, may be an industry group that includes 1 million employees with occupations that include both engineer and desk clerk. Of those 1 million employees 100,000 are engineers and the other 900,000 are desk clerks, with the engineers earning five times more than the desk clerks and the average weekly income of the entire group averaging within a few percentage points of the Job Quality Benchmark in any given month. Were the engineers' income to skew the income of the entire group just marginally above the Job Quality Benchmark then, ceteris paribus, all 1 million employees may be considered to have a high-quality job under the basic formulation of the JQI. In one example, only the 100,000 engineers have a high-quality job. Moreover, were the differences between the average weekly incomes of the entire group sufficiently close to the Job Quality Benchmark, absent any corrective measures, minor changes in the number of engineers and desk clerks within the large group of one million employees may have the effect of flipping the entire category from one side of the Job Quality Benchmark mean to the other from month to month.

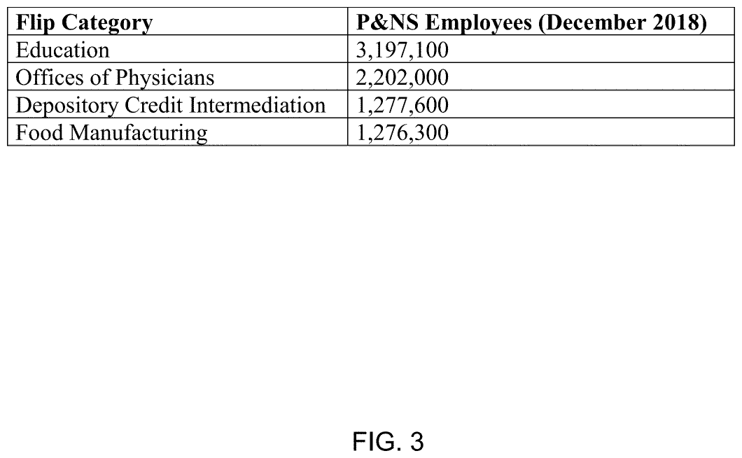

Accordingly, the processor 130 may address such larger, “flip category” industry groups of employees below which further sub-category analysis may render no material difference in (i) deviation from the mean or (ii) internal composition of high income to lower income jobs, sufficient to reduce the propensity of these groups to move back and forth across the Job Quality Benchmark mean. The processor 130 may parameterize a flip category as an industry that contains over a million employees and has an average weekly wage that typically falls within a predetermined percentage of the Job Quality Benchmark. Examples of industries that may satisfy the foregoing parameter are illustrated in FIG. 3.

In the aggregate, the four categories illustrated in FIG. 3 may comprise just over 7.5% of all private sector P&NS jobs in the U.S.

For purposes of the JQI, the processor 130 may subdivide these sectors using data provided by the annual Occupational Employment Statistics (OES) survey—which is released by the BLS annually in late March or early April. The OES may provide a more detailed breakdown of the wages for each occupation in each industry group. To maintain consistency, the processor 130 may not include occupations in the foregoing flip categories that involve supervisory roles. The processor 130 may apply the information from the OES to assess how many jobs within each flip industry are high- or low-quality occupations from the standpoint of weekly income and thereby split the larger industry category into subcategories. In one example, the processor 130 may filter the OES data to only include major occupations within each industry, normally this includes up to 24 different occupations.

Weekly wages derived from the OES may be then compared to the weekly wage benchmarks used in the preliminary JQI index. The occupations may be then assigned a quality of high or low depending on whether they are above or below the benchmark.

After this comparison is complete, the processor 130 may sum up the total number high-quality jobs and dividing it by the total number of jobs. Here, jobs may be indicated by the number of employees for that given occupation. This results in the percentage of high-quality jobs (and, correspondingly, low-quality jobs) for each of the flip categories. The relative percentage of high-quality/low-quality jobs may be now used to normalize and adjust each flip category. The processor 130 may multiply the percentage of high-quality/low-quality jobs by the CES employment count so that each flip category industry is split into two groups, which are then independently utilizes in the overall JQI calculation.

Because the OES data is released only once annually, the intra-year percentage divisions of the flip category industry groups may be adjusted annually, as well. The processor 130 may revise these percentage divisions (which do not change dramatically from year to year) each year to commence with JQI data released beginning in May of each year, through to the following April.

While the JQI may be released each month within hours of the release of the BLS U.S. Employment Situation data (generally on the first Friday of each month), certain industry subgroup data may lag data for larger categories by one month. Furthermore, while the raw JQI may be otherwise statistically consistent from month to month, even the adjustments heretofore mentioned may not remove all distracting statistical noise in movements of the index from month to month. The processor 130 may analyze the JQI and forecast when observed on the basis of a three-month moving average. The processor 130 may report the headline JQI index as such. Raw monthly data will be made available as well.

The JQI system 110 may filter occupations to only include major occupations. The JQI system 110 may include occupations at the major occupation level, which may be indicated by a two-digit occupational code. For instance, the logging industry may be split up into 13 major occupations, including business and financial operations occupations, protective service occupations, office and administrative support occupations, among other possibilities. The major occupation of business and financial operations occupations may include an occupational code of 13-000. The JQI system 110 may exclude subdivisions. The JQI system 110 may exclude further breakdowns by the OS. For example, purchasing agents, except wholesale, retail, and farm products may have an occupational code: 13-1023, which is a subdivision of the business and financial operations occupations category.

The JQI system 110 may calculate an adjusted JQI measure as follows. The flip category may have the following parameters: industry has a high propensity of “flipping” above and below the high-quality benchmark; industry contains at least 1 million employees; and if Industry(iₓ) satisfy the above parameters, then iₓ=fₓ
Flip Category=f={1, 2, 3, 4}
Occupation=o={1, 2, 3 . . . 24}
Year=y={1, 2, 3 . . . 29}

The JQI system 110 may begin the JQI adjustment process by collecting employment and annual wage data from the OS Survey for each occupation in the flip categories. Once doing so, the JQI system 110 may convert the annual wages into weekly wages for each occupation. The JQI system 110 may compare weekly wages derived from the OS Survey to the high-quality benchmarks used in the preliminary JQI index. The JQI system 110 may assign the occupations with a quality of high or low depending on if they are above or below the benchmark.

The JQI system 110 may calculate an occupational quality benchmark according to the following algorithm:

OQB_{y}=Σ(HQ(CES)_{my})/12

The JQI system 110 may find count of high-quality and low-quality occupation within each flip category. The processor 130 may establish a weekly wave for each occupation within a flip category using OS data.

WW(OS)_{ofy}=OA_{ofy}/51.143

The processor 130 may compare each flip category's WW(OS)_{ofy} to the OQB_{y}. Occupation is high quality if its weekly wage is greater than the occupational quality benchmark.

WW(OS)_{ofy}>OQB(OS)_{y}∴HQO_{ofy}

Occupation is low quality if its weekly wage is less than the occupational quality benchmark.

WW(OS)_{ofy}<OQB(OS)_{y}∴LQO_{ofy}

The processor 130 may find a percentage of high-quality occupations within each flip category.

$$H Q {\%}_{f y} = \frac{Σ H Q O o f y}{Σ O E o f y}$$

The processor 130 may use the employment numbers Emp_{fmy} given by the CES to indicate each flip category's job count.

The processor 130 may use the percentage of high-quality occupations to normalize the employment of flip categories within the Pre-JQI.

The processor 130 may determine the count of high-quality jobs for each flip category by multiplying HQ%_{fy} and Emp_{fmy}.

HQC(CES)_{fy}=HQ%_{fy}*Emp_{fmy}

The processor 130 determine the count of low-quality jobs for each flip category by multiplying 1−HQ%_{fy} and Emp_{fmy}.

LQC(CES)_{fy}=(1−HQ%_{fy})*Emp_{fmy}

The processor 130 may adjust the employment numbers in the pre-JQI by first removing all flip category employment numbers.

AdjEmp=ΣEmp_{imy}−Emp_{fmy}

The processor 130 may recalculate the Pre-JQI using the adjusted employment numbers.

$$Pre \text{-} J Q {I}_{my} = \frac{Σ HQI ( {AdjEmp}_{imy} )}{Σ LQI ( {AdjEmp}_{imy} )}$$

The processor 130 may complete JQI adjustment calculation by adding in the flip categories that are sorted into high and low occupations.

$${JQI}_{a d j} = \frac{Σ HQI ( Ad j E m {p}_{i m y} ) + H Q {C ( C E S )}_{f y}}{Σ LQI ( Ad j E m {p}_{i m y} ) + L Q {C ( C E S )}_{f y}}$$

In one embodiment, the processor 130 may subtract the flip category total employment numbers from the total employment. The processor 130 may add the high-quality employment count for each flip category to the high-quality employment count in the JQI index and vice versa. For example, the Offices of Physicians may contain 2,241,500 employees. Physician may be classified as a high-quality industry with the preliminary JQI. Using the OS Survey data, the JQI system 110 may find the percentage of high-quality jobs using the techniques discussed previously. For instance, the JQI system 110 may determine that the physician industry has a percentage of high-quality jobs at about 49%. Using this percentage, the JQI system 110 splits the employment numbers of the physician industry into high and low quality by multiplying the percentage of high-quality jobs by the total number of employment within the industry. In this case, 1,145,856 jobs would classify as low quality, so this value would be subtracted from the preliminary JQI's total number of high-quality jobs and added to the total number of low-quality jobs.

There may be differences in the values used in the CES and OES surveys. Differences in values between the CES and OS survey may be common for each flip category but may be most noticeable in the education category. Nevertheless, as the OES data may be only being used to subdivide P&NS employment in the education sector, and that sector—large as it is—may constitute just under 3% of total P&NS employment in the U.S.

Education may be also a special case for the JQI itself. Its values may be derived each month because the CES aggregates education and health services into one consolidated super-sector and only reports job count, hourly wage, and hours worked data for P&NS workers in the healthcare component (although education is broken out in the data covering all employees). For the JQI, education may be calculated by comparing the Education and Health Services Sector to the Health Services industry group. Employment may be found by finding the difference between the two groups. For average weekly hours and average hourly wages, algebra may be used to find the averages for education alone by using values from the first and second group.

Use of the occupational data may also restrict the livability of JQI index. Essentially, by using the OES, it may lock in a certain ratio of high-quality and low-quality jobs for that specific flip category. That ratio may be used for the entire year, until the next occupational survey is released. Therefore, during the year, the only thing that changes may be the amount of people added to the high- and low-quality job group but the ratio remains constant. For this reason, the processor 130 may be limited to four flip category industries, although conceivably the processor 130 may apply the OES data breakdowns to more sectors in order to further dampen month over month volatility of the JQI.

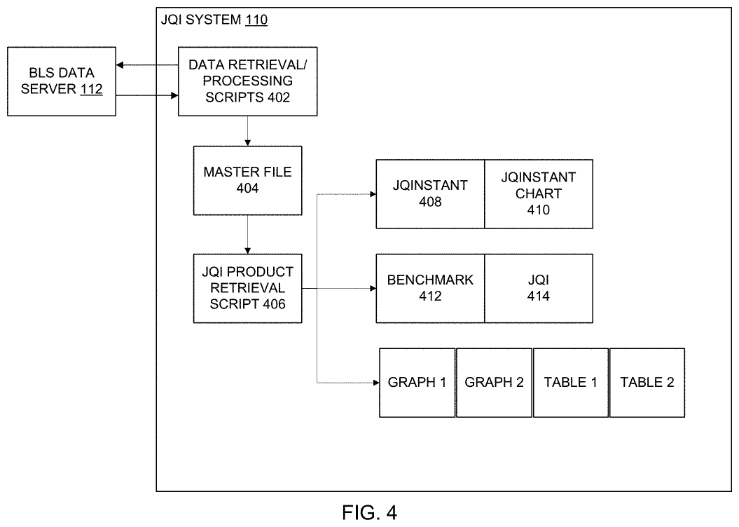

FIG. 4 illustrates an example diagram for calculating JQI. The JQI system 110 may include data retrieval to processing scripts 402 to communicate with the BLS data server 112. The scripts 402 may be python scripts. The scripts 402 may be used to retrieve data and populate data into a master file 404. The scripts 402 may send CES codes to the BLS data server 112 for data request. The scripts 402 may send the query to the BLS data server 112 for JSON data, which allow faster data parsing and less file I/O. In response, the BLS data server 112 may return BLS API (JSON).

The data that is retrieved as JSON using the python scripts may be then populated into employment, hours and wage sheets. This may be the only data needed for the master file 404 to utilize changes made in the last step to calculate the JQI values. After the process is run, and the master file 404 is populated. The JQI product retrieval script 406 may output JQInstant value 408, JQInstant chart 410, weekly wage benchmark 412, JQI index value 414, graphs 1 and 2 as well as tables 1 and 2 for the jobs day report.

Graphs 1 and 2 may show JQI index values over different time periods. Table 1 may show weekly wage data as found in the master file 404. Table 2 may show CPI adjusted index based on the weekly wage for each category.

The building of these charts and tables may be part of an automated process also written in python where the necessary values are pulled from the master file 404 and placed into template sheets with any necessary calculation residing in their perspective cells. Once the data is populated, calculations may automatically compute and the finished product is complete.

The python scripts may include an error checking process where if a cell should contain a specific formula but does not, python will place the correct formula. The process may exist in all python automated process.

In one embodiment, the BLS data may be stored in an SQL database and provided on demand to a Hypertext Preprocessor (PHP) that calculates the relevant values. The data stored permanently may include: all employees, production and nonsupervisory employees, average weekly hours of production and nonsupervisory employees, average hourly earnings of production and nonsupervisory employees, and consumer price index. The PHP processor may serve those values to the requestor and use those values to calculate all values previously calculated in the excel processor. The values may either be calculated on the fly or recalled from the database of previously calculated excel values. Both options may utilize the same formulas and same data inputs therefore may yield the same results. The final values after processing may be provided on demand to the users of the website allowing filtering to be provided and used to refine data. The data that is calculated by the processor may include: Table 1 (A/B), Table 2 (A/B), Average Weekly Wage, JQI and JQI 3 Month Trailing Average, JQI Adjusted and JQI Adjusted 3 Month Trailing Average, JQ-Instant (Bar Chart and Values), and JQB—Job Quality Benchmark.

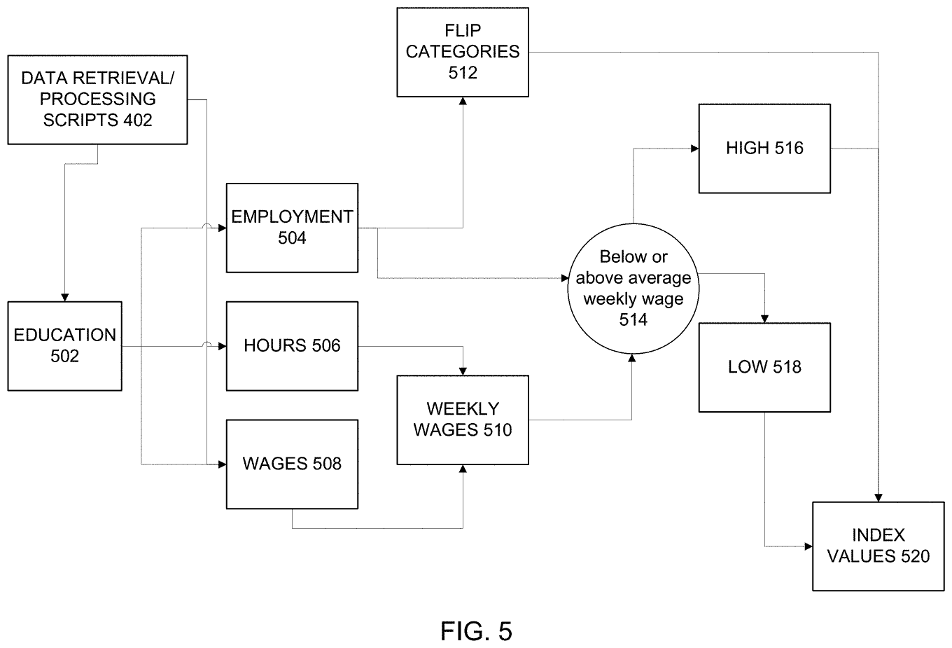

FIG. 5 illustrates an example flowchart for calculating JQI. Education data 502, employment data 504, hours 506 and wages 508 may be populated based on the data retrieved by the data retrieval/processing scripts 402. Weekly wages 510 may be computed based on hours 506 and wages 508. Flip categories 512 may be determined based on the employment data 504. The employment data 504 and the weekly wages 510 may be used to compute whether wages are below or above average weekly wage 514. High quality jobs 516, low quality jobs 518, and flip categories 512 may be used to determine JQI index values 520.

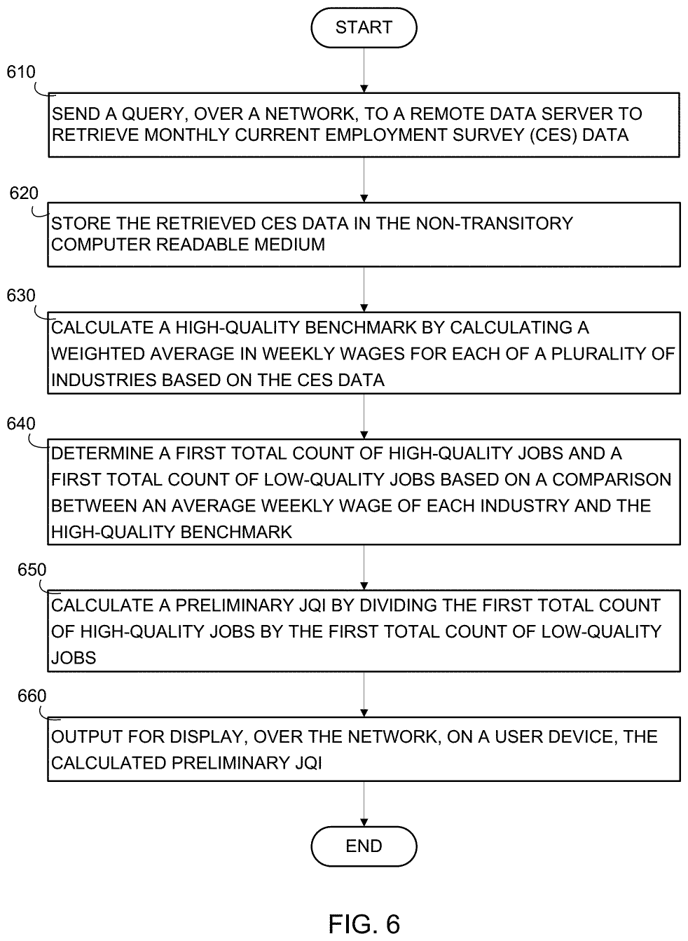

FIG. 6 illustrates an example flow chart of a monitoring process performed by the JQI system 110. At 610, a processor 130 (or one or more processors, which is used interchangeably with “a” processor in the present disclosure) of the JQI system 110 may send a query, over the network 180, to a remote data server, such as the BLS data server 112, to retrieve monthly CES data.

With continued reference to FIG. 6, at 620, the processor 130 may store, in the non-transitory computer readable medium 140, the retrieved CES data. At 630, the processor 130 may calculate a high-quality benchmark by calculating a weighted average in weekly wages for each of a plurality of industries based on the CES data. At 640, the processor 130 may determine a first total count of high-quality jobs and a first total count of low-quality jobs based on a comparison between an average weekly wage of each industry and the high-quality benchmark. At 650, the processor 130 may calculate a preliminary JQI by dividing the first total count of high-quality jobs by the first total count of low-quality jobs. At 660, the processor 130 may output for display, over the network 180, on the user device 120, the calculated preliminary JQI.

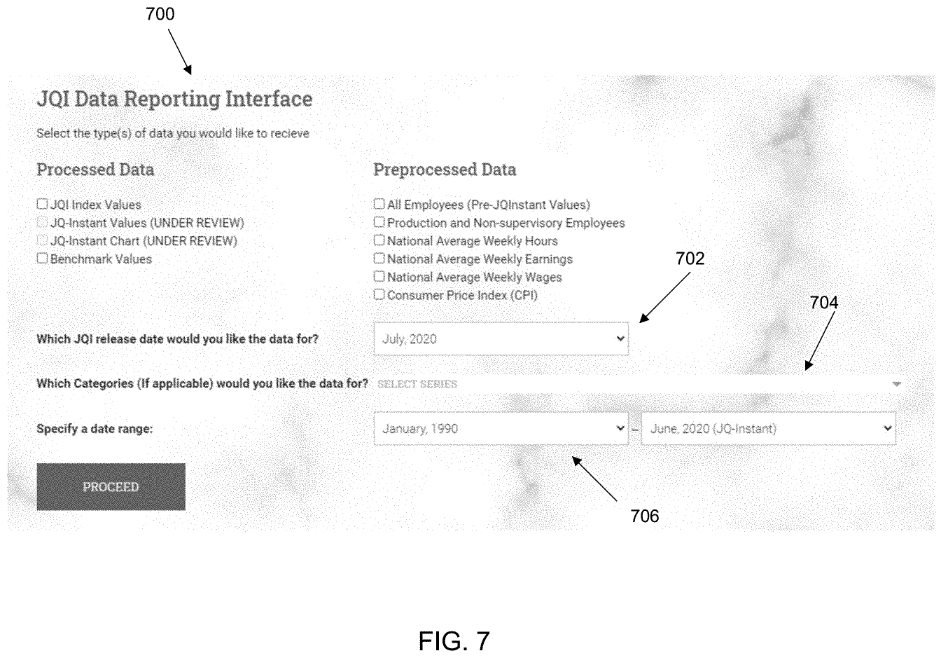

FIG. 7 illustrates an example report interface 700 with filters. The interface 700 may allow filtering reports on the following criteria: release date 702, categories 704, and date 706. The release date 702 filter may allow a user to choose which release data to use for the reporting. Data may be amended every release, so the data outputted is different based on this value. Categories 704 filter may allow the user to choose all or only a subset of the available industries for reporting. Date 706 filter may allow the user to limit the length of the report to a specific timeframe.

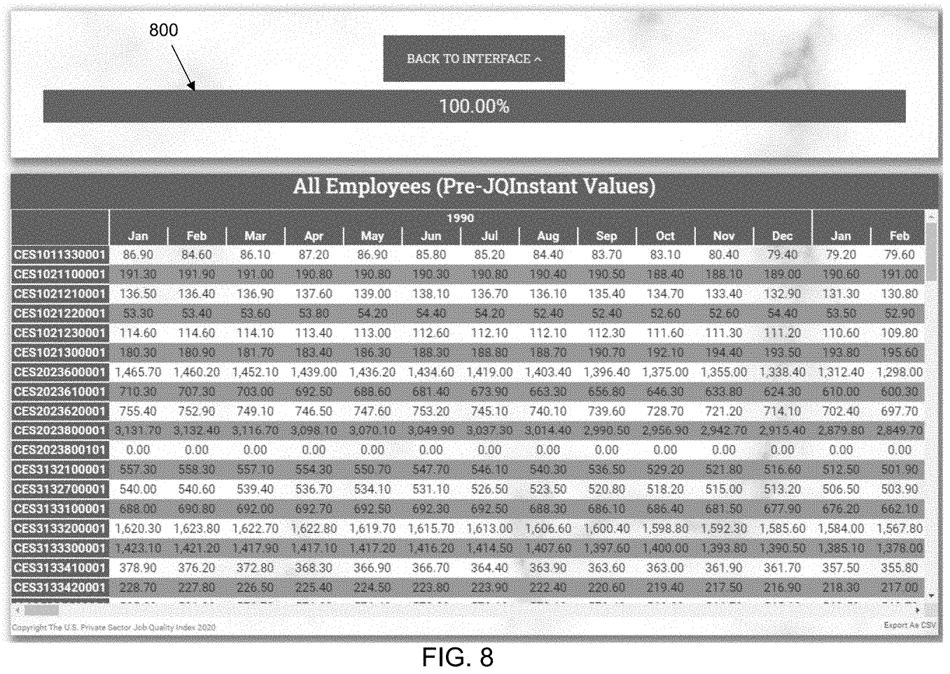

FIG. 8 illustrates an example report result 800 with no filters applied.

The processor 130 may maintain the JQI by performing monthly data querying with the BLS data server 112. The processor 130 may send queries to the BLS data server 112 to retrieve data. When new data is released at the beginning of each month, the processor 130 may automatically send queries, such as python script, to contact the BLS data server 112 and quickly gather all the necessary data used for the JQI in real time. Once the data is collected and organized, the processor 130 may automatically in real time begin an updating process by calculating the high-quality benchmark for the new month. The processor 130 may automatically find the count of high/low quality jobs to form the preliminary JQI measure, and then adjust the preliminary JQI by correcting for the flip categories. The processor 130 may automatically in real time send the calculated JQI to one or one users or subscribers via any type of alert, such as email or text messages.

The python script used to contact the BLS data may be easily modified and expanded to include more (or less) industries. For the future, the data used in the JQI may expand to include all employees, rather than limiting itself to P&NS Employees. Furthermore, the JQI system 110 may also expand/contract the amount of industries used within the area of observation. The JQI may have a representative sample of 180 industries within the US economy.

The ability for this measure to be expanded may provide greater prospective around the job quality in economy. The JQI system 110 may compare various versions of the JQI. The comparison may provide greater analytical insight regarding the job health of the economy, the differing distributions of U.S. jobs between JQI Measures, and the trajectories of weekly pay between high/low cohorts.

The JQI system 110 may perform and publish monthly revisions to the JQI contemporaneously with the monthly release of U.S. employment situation data by the BLS, e.g., generally on the first Friday of each calendar month. The JQI system 110 may publish monthly revisions to the JQI at one or more websites. Further, the JQI system 110 may publish monthly revisions to the JQI by issuing press release, or sending emails or text messages to subscribed users.

In one embodiment, the JQI system 110 may generate a first JQI, such as an initial form of JQI that covers only P&NS workers, which may amount to approximately 82.4% of the total number of private sector job positions in the U.S. Data on P&NS positions offers far greater historical granularity than data incorporating management and supervisory positions (the remaining 17.6% of U.S. jobs) during periods prior to current century and is more useful for historical comparative purposes.

In addition, the JQI system 110 may generate a second JQI, which is a companion index that covers all employees. The second JQI may track all private sector job, with data commencing, for example, in 2000. The first JQI and the second JQI may be run and maintained side-by-side.

The JQI may measure the quality of job, not quality of employment. The BLS Current Population Survey (CPS) contains data on employment and indicates that, as of December 2018, some 156.7 million people were employed (for at least one hour within the survey reference week) in the U.S. This contrasts with a total of 150.3 million non-farm jobs, per the CES. The difference between the two is accounted for in the inclusion in the CPS (and exclusion from the CES) of agricultural, self-employed, household, and unpaid family workers (with at least 15 hours of weekly work), as well as those on leave without pay. Conversely, only workers above the age of 16 are counted in the CPS, whereas all jobs—regardless of the age of the holder, or number of hours worked—are counted in the CES. Finally, a job is a job per the CES: regardless of whether or not it is held by a worker who holds more than one job.

The JQI system 110 may have stored therein one or more threshold values in the non-transitory computer readable medium 140 for triggering an alert to one or more users. When the first JQI or the second JQI exceeds or drops below a certain threshold value, the processor may 130 automatically generate an alert, and send the alert to one or more user devices 120. The alert may include the JQI alone, or in combination with other contemporaneous data.

In one example, the JQI generated by the JQI system 110 may provide a predictive use in the financial markets and economic policy making. The relative supply and demand in an economy (including internal and external sources thereof) is, notwithstanding the claims of monetarist economists to the contrary, the proximate cause of inflation and deflation. As seen in this century, while money supply can influence production and consumption, unless the supply of money transmits (in terms of both injection and velocity), relatively broadly, to primary investment and employment (or the contraction of money supply succeeds in doing the opposite), the increase or decrease in the supply of money itself will not have the impact intended by monetary policy makers.

For reasons that have been extensively researched, the transmission of increased money supply to aggregate demand has reached its own form of a zero lower bound over the course of the past several decades. Despite central banks in the U.S., the Eurozone, Japan and the U.K. having pumped over $10 trillion into their collective economies over the past decade, aggregate demand remains tepid and inflation, therefore, has not sustainably recovered to the target levels intended by central bankers.

With interest rates on sovereign debt issued by countries in their own currencies being, at the margin, almost entirely a function of growth- and therefore inflation-expectations for the issuing nation (on a relative basis to all other risk-free sovereign issuers), it is reasonable to look for data points that serve as modulators of transmission, or the lack thereof, of conventional metrics—such as growth or contraction of monetary policy, employment and investment—to aggregate demand, to growth, and ultimately to inflation and prevailing sovereign interest rates.

Changes in the JQI may correlate to changes in market-determined (that is to say, the longer end of the yield curve, as opposed to shorter obligations that reflect monetary policy itself) U.S. sovereign interest rates both over the long term and with respect to shorter term fluctuations thereof. The JQI, in expressing relative demand for more highly compensated workers from one moment in time to another, may be reflective of overall economic growth trajectories between those points. The JQI system 110 may detect upticks and reversals in the JQI, which may predict future growth expectations and, therefore, the likely trajectory of domestic interest rates.

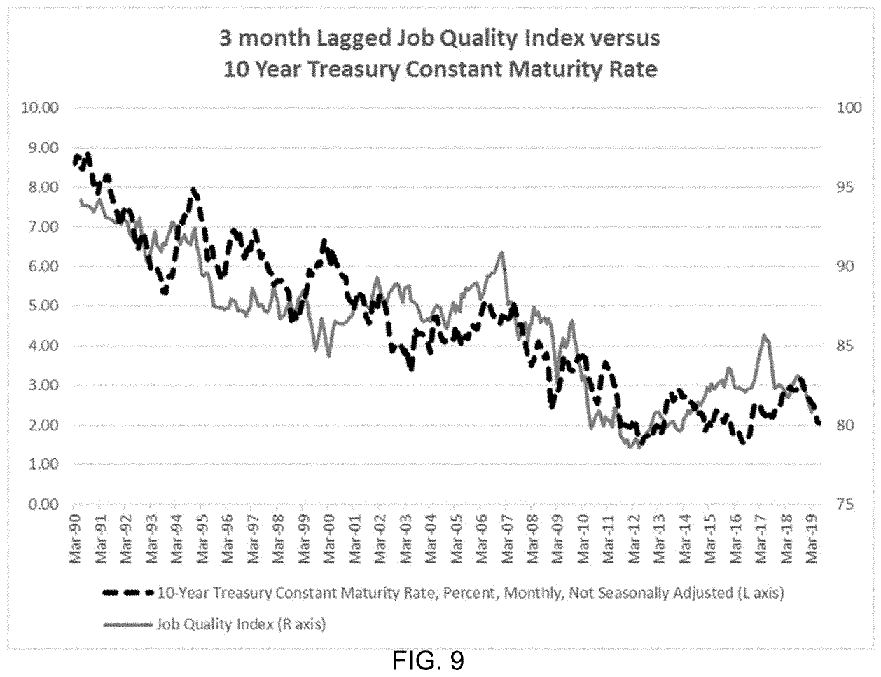

The JQI system 110 may retrieve data from one or more external databases, such as treasury server 122. The JQI system 110 may generate one or more diagrams displaying the calculated JQI over other economic data, such as data from the treasury server 122, for users to easily view correlations. For instance, the JQI system 110 may retrieve treasury constant maturity rate from the treasury server 122. The JQI system 110 may calculate a 3-month moving average JQI. The JQI system 110 may automatically generate a diagram, such as shown in FIG. 9, illustrating the constant maturity yield on a 10-year U.S. Treasury bond against the calculated JQI on a 3-month lagged basis. While not consistent with respect to the amplitude of fluctuations, FIG. 9 illustrates a high level of correlation in terms of directionality—especially in the second half (last 15 years). In other words, turns in the direction of the JQI appear to be associated with turns in the direction of bond yields. After calculating the JQI, the JQI system 110 may detect a change in direction of the JQI over time. The JQI system 110 may compare the detected change in direction to a predetermined threshold value. When the detected change meets the predetermined threshold value, the JQI system 110 may predict a movement or change in the financial markets and economic policy making. The JQI system 110 may send an alert reporting the predicted movement or change to one or more user devices. In one example, the change in direction of the JQI may suggest an inflation direction. The JQI system 110 may automatically detect a JQI increase. If the increase exceeds a certain threshold value, the JQI system may automatically generate an alert, and transmit the alert to one or more user devices 120. The alert may indicate a potential inflation rate increase.

In one embodiment, the JQI system 110 may send the calculated JQI and any update of the JQI, or any ancillary values, to a trading platform of futures market to price securities and permit trading.

Returning back to FIG. 1, which provides a block diagram of an example JQI system 110 that may implement certain aspects of the present disclosure. Each JQI system 110 may include one or more physical or logical devices (e.g., servers).

The JQI system 110 may include the processor 130, the non-transitory computer readable medium 140 containing an operating system (“OS”) 142, a database 144 and a program 146, and an input/output (“I/O”) device 150. For example, the JQI system 110 may be a single device or server or may be configured as a distributed computer system including multiple servers, devices, or computers that interoperate to perform one or more of the processes and functionalities associated with the disclosed embodiments. In some embodiments, the JQI system 110 may further include a peripheral interface, a transceiver, a mobile network interface in communication with the processor 130, a bus configured to facilitate communication between the various components of the JQI system 110, and a power source configured to power one or more components of the JQI system 110.

A peripheral interface may include hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™ ambient backscatter communications (ABC) protocols or similar technologies.

A mobile network interface may provide access to a cellular network, the Internet, a local area network, or another wide-area network. In some embodiments, a mobile network interface may include hardware, firmware, and/or software that allows the processor(s) 130 to communicate with other devices via wired or wireless networks, whether local or wide area, private or public, as known in the art. A power source may be configured to provide an appropriate alternating current (AC) or direct current (DC) to power components.

The processor 130 may include one or more of a microprocessor, microcontroller, digital signal processor, co-processor or the like or combinations thereof capable of executing stored instructions and operating upon stored data. The processor 130 may be one or more known processing devices, such as a microprocessor from the Pentium™ family manufactured by Intel™ or the Turion™ family manufactured by AMD™. The processor 130 may constitute a single core or multiple core processor that executes parallel processes simultaneously. For example, the processor 130 may be a single core processor that is configured with virtual processing technologies. In certain embodiments, the processor 130 may use logical processors to simultaneously execute and control multiple processes. The processor 130 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

The non-transitory computer readable medium 140 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the non-transitory computer readable medium 140. The non-transitory computer readable medium 140 may include one or more memory devices that store data and instructions used to perform one or more features of the disclosed embodiments. The non-transitory computer readable medium 140 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The non-transitory computer readable medium 140 may include software components that, when executed by the processor 130, perform one or more processes consistent with the disclosed embodiments. In some embodiments, the non-transitory computer readable medium 140 may include the database 144 to perform one or more of the processes and functionalities associated with the disclosed embodiments. The non-transitory computer readable medium 140 may include one or more programs 146 to perform one or more functions of the disclosed embodiments. Moreover, the processor 130 may execute one or more programs 146 located remotely from the JQI system 110. For example, the JQI system 110 may access one or more remote programs 146, that, when executed, perform functions related to disclosed embodiments.

The JQI system 110 may also include one or more I/O devices 150 that may comprise one or more interfaces for receiving signals or input from devices and providing signals or output to one or more devices that allow data to be received and/or transmitted by the JQI system 110. For example, the JQI system 110 may include interface components, which may provide interfaces to one or more input devices, such as one or more keyboards, mouse devices, touch screens, track pads, trackballs, scroll wheels, digital cameras, microphones, sensors, and the like, that enable the JQI system 110 to receive data from one or more users. The JQI system 110 may include a display, a screen, a touchpad, or the like for displaying images, videos, data, or other information. The I/O devices 620 may include the graphical user interface 622.

In exemplary embodiments of the disclosed technology, the JQI system 110 may include any number of hardware and/or software applications that are executed to facilitate any of the operations. The one or more I/O interfaces 152 may be utilized to receive or collect data and/or user instructions from a wide variety of input devices. Received data may be processed by one or more computer processors as desired in various implementations of the disclosed technology and/or stored in one or more memory devices.

Turning back to FIG. 1, the user devices 120 in the system environment 100 may each be a personal computer, a smartphone, a laptop computer, a tablet, or other personal computing device. Each user device 120 may run and display one or more applications. In certain implementations according to the present disclosure, the user device 120 may include one or more applications and/or one or more processors. The one or more applications may provide a graphical display including a field for a user to enter a request to access code associated with a web page. The user request may include a uniform resource locator (URL). In some cases, the user request may be a request to run and/or access one or more web-based applications provided by one or more JQI systems 110. User device 120 can include one or more of a mobile device, smart phone, general purpose computer, tablet computer, laptop computer, telephone, PSTN landline, smart wearable device, voice command device, other mobile computing device, or any other device capable of communicating with network 180 and ultimately communicating with one or more JQI systems 110. According to some embodiments, the user device 120 may communicate with one or more JQI systems 110 via the network 180.

The networks 180 may include a network of interconnected computing devices more commonly referred to as the internet. The network 180 may be of any suitable type, including individual connections via the internet such as cellular or WiFi networks. In some embodiments, the network 180 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security. The network 180 may comprise any type of computer networking arrangement used to exchange data. For example, the network 180 may be the Internet, a private data network, virtual private network using a public network, and/or other suitable connection(s) that enables components in system environment 100 to send and receive information between the components of system 100. The network 180 may also include a public switched telephone network (“PSTN”) and/or a wireless network. The network 180 may also include local network that comprises any type of computer networking arrangement used to exchange data in a localized area, such as WiFi, Bluetooth™ Ethernet, and other suitable network connections that enable components of system environment 100 to interact with one another.

2. Advantage

2.1 Weakening Trend

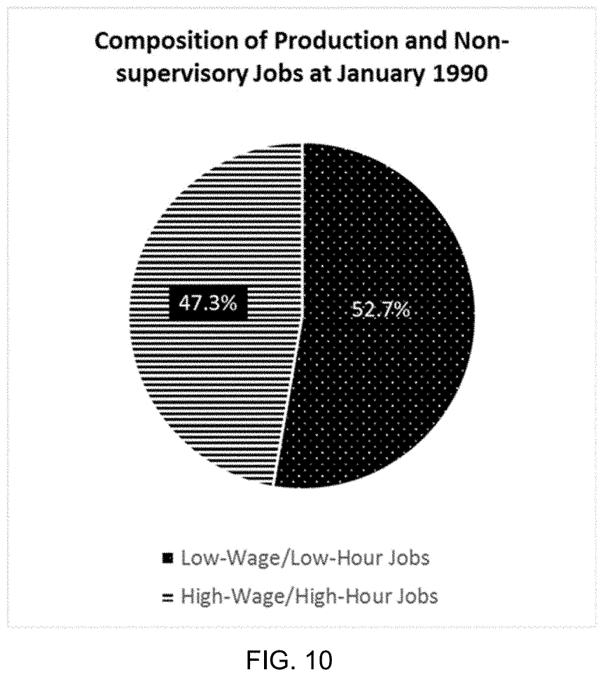

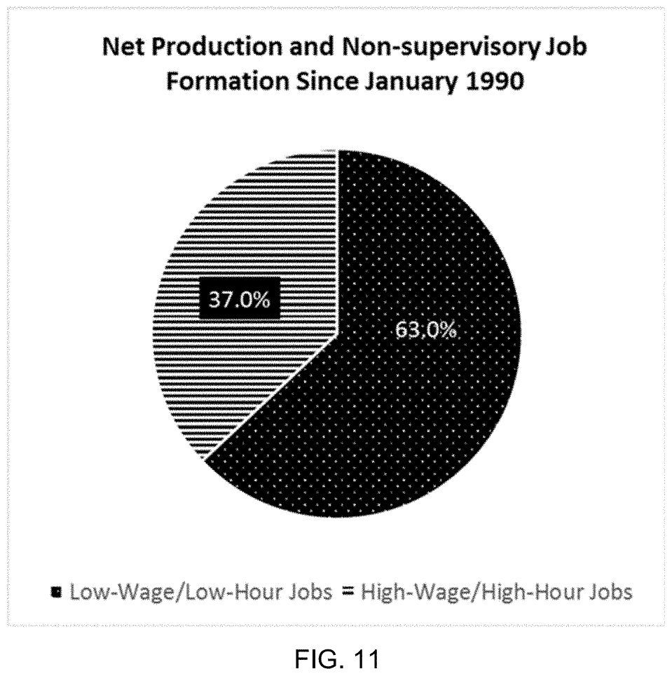

There has always been a hefty concentration of labor in lower quality jobs. Over the past three decades, however, this concentration has increased in a manner that is significant in an overall sense, since the commencement date of the JQI in 1990, moving from an index level of 94.9 in that year to 79.0 as of July 2019. Observed in a different manner, low-wage/low-hours jobs constituted 52.7% of total P&NS positions in 1990 as illustrated in FIG. 10, while in the years since, they have accounted for 63% of all P&NS jobs created as illustrated in FIG. 11. Diagrams illustrated in FIGS. 10 and 11 may be automatically generated by the JQI system 110.

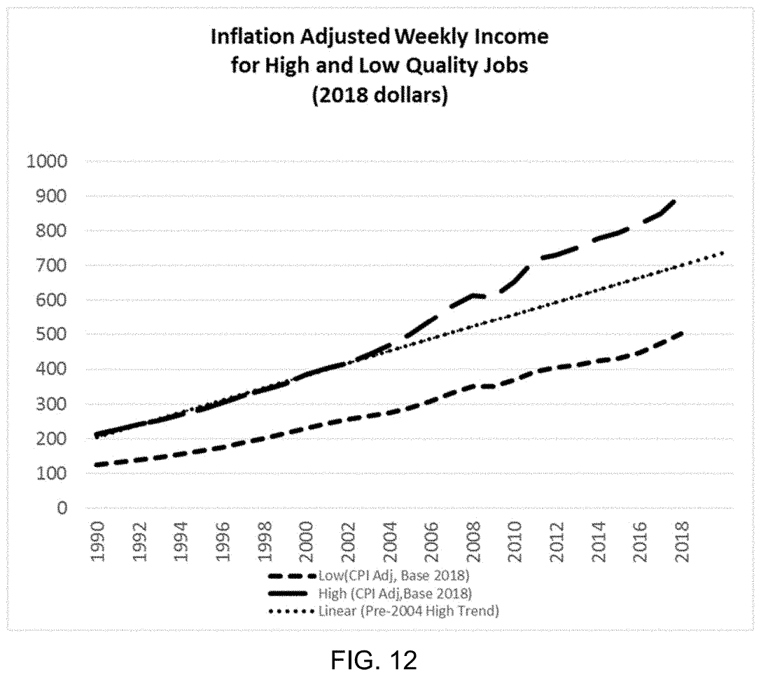

Moreover, not only has the mix of high and low quality P&NS jobs changed in favor of the latter over the past three decades, but the gap in weekly income between the two groups has widened as well. As illustrated in FIG. 12, which may be automatically generated by the JQI system 110, on an inflation adjusted basis (in 2018 dollars) that gap has widened almost four-fold to $402 in 2018 from $104 in 1990. While that inflation-adjusted differential broadened somewhat from 1990 to 2002, the trend growth in weekly wages of high quality jobs broke dramatically higher beginning in 2004, with only minor disruption in escalation during the Great Recession.

A relatively small portion of this differential has resulted from the fact that hourly wages for the high-quality group grew 10% more overall than those of the low-quality group when adjusting for inflation over the period. The predominant differential between the cohorts results from (a) the dramatic difference in hours worked on high quality vs. low quality P&NS jobs and (b) that low quality jobs have seen a net reduction in hours worked per week of 6/10ₜₕₛ of an hour from 1990 to 2018 (and a full hour from their peak 31.0 hours worked in 1999 to 30.0 hours today), while high quality jobs have basically held flat over that period at 38.3 hours per week and have shaved only 24 minutes from their all-time high levels in 1997.

The foregoing phenomena are, of course, linked to fundamental underlying changes in the nature of the economy and employment. Putting aside, for the moment that the changing mix of private sector jobs in the U.S. economy (favoring lower quality positions) is a factor in delivering the persistent declines in labor's share of overall production, it is useful to further examine related shifts in employment patterns that may be connected with the weakening trends, as well as the erosion in the JQI. Three areas warrant particular attention: (i) increases in service sector employment, (ii) changes in the number of people working part time, and (iii) changes in the number of workers who are self-employed, including those in the so-called “gig” economy.

The U.S. economy, especially after the Great Recession, has reached a point which may prove to be “maximum service employment.” This claim is obviously difficult to prove, but it stands to reason that there must be a level of goods production that an economy is obligated to retain (construction, mining, heavy industrial goods, food, energy, etc.) merely by virtue of geography and physics. The history of the situation is, however, quite clear. In the early 1960s, private service sector employment stood at approximately 58% of total private sector employment. By 1990, private service sector employment had risen to approximately 73% of the total—a figure which rose steadily until the Great Recession, during and after which it jumped to its present level of approximately 83%. As the ratio has held steady since (for an unprecedented period of nearly a decade) it may be well be that the speculation at the beginning of this paragraph will be borne out with the passage of additional time.

As weekly earnings of services sector jobs have, to an increasing degree, materially lagged those of jobs in the goods producing sector an increase of the percentage of service sector jobs would naturally result in an increase in the number of jobs below the mean, as reflected in the JQI. This is undoubtedly the principal, but by no means the only, factor delivering the results observed here. Conversely, however, attention should be given to the failure of the services sector to itself generate a thriving employment situation contrary to oft-heard tropes regarding service jobs of the information/digital age. Taken as a whole, weekly earnings of services sector P&NS employees, relative to those in the goods producing sector, fell most dramatically during the 1970s and early 1980s when the ratio declined from roughly 92% to 67%. The recovery thereafter did correspond with the high productivity boost seen in the early internet technology era from 1995 through 2003, but has stalled since with the ratio actually downtrending from 2015 through 2018, to 73.25% at the end of last year.

Moving on, then, to the issues of part-time and self-employed workers (which are addressed together not only for reasons of expediency but because they intersect at a number of levels), there are two principal observations that are both relevant to the importance of the JQI, and that run contrary to what may be characterized as the collective wisdom on these issues.

First, as to part-time employment, while workers reporting that they worked fewer than 35 hours per week (one or more jobs) spiked, during the last recession, to nearly 20% of those employed, the level at the end of 2018 was 17.8%, approximately equal to that of the mid-1980s. The number of part-time workers who would prefer full time employment remained higher for longer after the Great Recession than was typical in the past, but has subsided significantly to near-normal levels. While rising measurably on a nominal basis since the Great Recession, as in prior recoveries, the number of workers reporting employment in multiple jobs (one or both of which per the CPS may or may not be jobs with third-party employers) as a percentage of those employed has been declining fairly steadily since 1996 and has fluctuated between a historically low of approximately 4.75% and 5.25% for the past 10 years.

Second, with regard to the national economy's dependence on self-employment and gig working, the data is not generally supportive of what has become somewhat popular narrative regarding substantial changes in modes of work. While there are approximately 15 million loosely-defined “self-employed” workers in the U.S., if workers in self-owned incorporated business are included (that generally employ others as well)—about 40% of the total, the self-employment rate has declined over the past decades. Furthermore, self-employment is heavily concentrated among older workers. Another way of tracking self-employment, as well as dependence on agricultural, household and unpaid family work is to calculate the variance between the number of workers counted as employed under the CPS and the number of non-farm jobs at establishments in the CES (this would eliminate establishment owner/employees among other things).

Therefore, there is no material change in the style of employment in the U.S. The problem in the U.S. employment situation is that the quality of the jobs that are on offer (as measured by relative weekly pay) has, for the most part, been declining. That fact is (a) one of the principal drivers of the sustained depression of the U.S. labor force participation rate and an increase in the number of workers marginally attached to the labor force; and (b) is a missing link in assessments of labor slack and job openings in the U.S.

It should be obvious that if the jobs on offer are not attractive to workers relative to their cost of living, they will not be taken up. Conversely, if 63% of the net jobs created in the economy since 1990 provide an average of less than 30 hours a week of work (often on uncertain schedules), there are a lot of people with excess labor to contribute. If living standards are to rise in the U.S., the nation is not in need of more low-wage/low-hours jobs.

2.2 the JQI—a Dynamic Measurement of Effective Underemployment

There are shortcomings of the more prominent measures of the employment situation. There are several factors that present a picture of employment that is substantially at odds with the low U3 unemployment and the relatively salutary pace of overall job creation over the past several years.

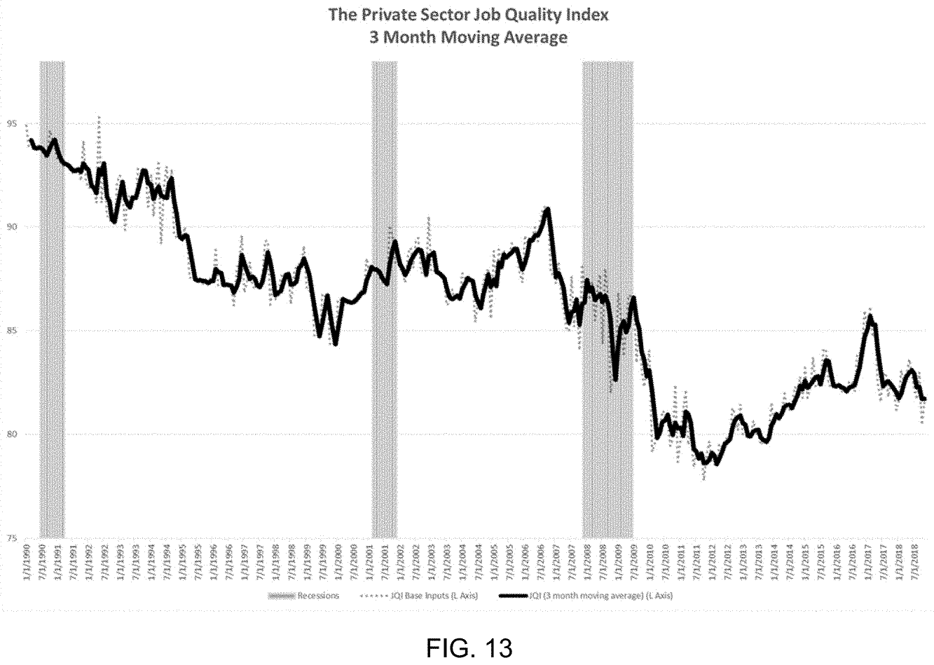

The JQI may be presented as a three-month rolling average of monthly readings. This may be done to dampen month over month variability which is unreliable as a directional trend measure. FIG. 13 incorporates monthly readings as a partially transparent series behind the principally reported three-month average. The diagrams illustrated in FIG. 13 may be automatically generated by the JQI system 110.

Even utilizing a three-month rolling average of monthly readings, the JQI has proven to be timely predictive of changes (and in some periods, and with some data, reflective of changes) in underlying economic conditions and financial indicators, labor force changes, global trade patterns, domestic productivity and other factors effecting domestic job quality.

The JQI may be complementary to other measures of employment or unemployment—acting, to a large extent, as the essential “grain of salt” with which the other data is to be taken.

Prominent in FIG. 13 is the long-term overall decline in the JQI. This is confirmatory of the sustained and increasing level of dependence of the U.S. employment situation on private P&NS jobs that are below the mean level of weekly wages. Secondly, there are two waves of substantial erosion in the index level—that of the early 1990s and that of the Great Recession itself—and in neither case did the stability and partial recovery that followed restore the index to its level prior to those declines. This is an indication of the long-term secular nature of the factors that contribute to the JQI readings. Movements in the JQI are only modestly correlated with recession—as evidenced by the stability of the index during the 2001 recession, and the continued declines in the index following the 1990-1991 recession and the Great Recession (although continued deterioration to the employment situation following the technical end of a recession is not unexpected). There is, however, some cyclical patterning evidenced in the JQI output, but is overwhelmed by a larger secular phenomenon.

The most prominent factor which to be associated with the multi-decade decline in the JQI is the relative devaluation of U.S. (along with that of other advanced nations') domestic labor that followed the emergence of exogenous sources of labor, principally in the post-socialist economies. Especially in the goods producing and, more recently, high-value-added service sectors (intellectual property creation, financial services and communications/information services sectors) to which production can be shifted as demand and costs dictate. This dynamic, from a domestic labor value perspective, has been decidedly and relentless a negative one. There have, however, been periods of moderation as other influences have asserted themselves.

The upshot, however, is the “effective underemployment” within the domestic labor force, as mentioned earlier—consisting chiefly of two contributing factors: (i) more workers employed in jobs offering fewer hours of work; and (ii) fewer workers drawn into the labor force—not because of a dearth of jobs, but because of the quality thereof relative to the quality of life while not participating in the labor force.

With respect to the former, the loss of hours (across the spectrum of high- and low-quality jobs, but heavily concentrated in the low-quality positions) totals almost exactly one full hour per week. Based on the 2018 year-end 34 hour/week average for the 105,244,000 P&NS jobs, that translates into the unutilized man/hour equivalent of 3.1 million jobs ((105,244,000×1 hour)/34 average hours)).

Observed in a more extreme example, consider that the JQI's definition of high-quality jobs (those above mean weekly earnings) provided an average of 38.26 hours of weekly work at year end 2018, compared with low quality (those below the mean) which provided 29.98 hours. If the average P&NS worker in low quality jobs were working for the same number of average hours as those in high quality, that would translate into the unutilized man/hour equivalent of a whopping 12.6 million jobs:

| | | |
|---|---|---|
| Average Hours/Week High Quality | | 38.26 |
| Average Hours/Week Low Quality | | 29.98 |
| Variance | | 8.28 |
| Low Quality P&NS Jobs | x | 58,044,000 |
| “Underworked Hours” | | 480,604,320 |
| Divided by High Quality Hours | | 38.26 |
| Unutilized man/hour Equivalent Jobs | | 12,561,535 |

Now, of course, low quality jobs are short hour positions not because employers are out to short-change workers. Some are workers in part-time positions—as noted above. Some low quality jobs are deliberately kept by employers below mandated benefit thresholds (but an analysis of the data does not support a temporal trend towards shorter hours related to the oft-cited commencement of the requirements under the Affordable Care Act (“ACA”), enacted in 2010 and becoming fully effective in 2014). There have always been a subset of low-hours jobs offered by firms. But it is equally undeniable that as the ratio of low-hours jobs increases to a larger percentage of the total, overall labor utilization declines as a result. Perhaps not to the extent indicated in the calculation immediately above, but most likely to a greater degree than the loss of one hour of work among all P&NS jobs. The answer, logically, lies somewhere in between.

Overall, the foregoing analysis of JQI data certainly points more to the existence of hidden labor slack than otherwise. Another similar indicator can be teased out of more conventional data, using the JQI as confirmation.

Economists and many others in the general public are by now all too familiar with the material decline in the labor force participation rate (LFPR) and the employment population ratio in the U.S. during the 21^{st} century and, especially, since the Great Recession. The LFPR is the ratio of those regarded as being in the labor force to the civilian non-institutional population (CNIP), and the employment population ratio (EP) is those employed as a percentage of the CNIP. These phenomena are most frequently chalked up to the aging of the U.S. population, and that is—most assuredly—a significant factor. But solely relying on that explanation, or even largely doing so, can be misleading.

It is unquestionably true that the median age of the U.S. population has grown from a modern era low of about 28 years in the 1970s, to nearly 38 years of age today. Yet the rate of aging in the present decade (during which the LFPR and EP have remained most depressed), given the sheer size of the millennial generation, is slower than in the past and appears to be leveling off.

| Decade | Change in Years |
|---|---|
| 1980s | 2.9 |
| 1990s | 2.4 |
| 2000s | 1.9 |
| 2011-2017 | 0.8 |

The current era is not the first time that the civilian non-institutional population (CNIP) of the prime-working-age 25 to 54 year old cohort has declined dramatically as a percentage of the total CNIP. The same thing happened in the 1960s/early 1970s, but was the result of an enormous influx of people into the 16 to 24 year old cohort. Nevertheless, the LFPR of the prime-aged cohort increased during that period from below 70% to around 85% (some of which was the result of an influx of women into the labor force, but certainly there was no evidence of decline). The participation rates of the oldest cohorts (55 to 64 and over 65 years of age, respectively) were roughly the same as they have again risen to today—roughly 63% and 20%, respectively.

Along with the rise in the 16 to 24 year old CNIP cohort in the 1960s/early 1970s came an increase in the labor force participation of that cohort. A fairly dramatic increase to 69.1% from 54.4% over 15 years. This is, among other things, indicative of the jobs available to that cohort which, back in that period, had an approximate college completion level ranging from only 11% and 15%, and a high school completion level of 65% to 75%, depending on the year of measurement. Based on the educational attainment levels of the 25-29 year old cohort from 1963-1978 as set forth in https://www.census.gov/content/dam/Census/library/publications/2016/demo/p20-578.pdf

It is reasonable to assume, therefore, that the jobs available in the 1960s and 70s were commensurate with the absorption of a large increase in the number of modestly educated, young and inexperienced eligible workers. This is consistent, of course, with the substantially higher percentage of goods producing jobs in the U.S. economy during that period. Manufacturing, construction, mining jobs, as well as jobs in the services sector (wholesale trade, transportation, and utilities, among others) that support them, are—today as in earlier periods—generally higher quality (from a JQI perspective) than the services jobs that dominate job formation in 21^{st} century America.

Unlike the rising trend of LFPR among the prime-aged 25 to 54 year old cohort during the 1960s and '70s, while its relative percentage of the CNIP was declining—today there is a rather depressed level of LFPR recovery (following a substantial decline during this century) among prime aged workers. Moreover, the LFPR of the 16 to 24 year old cohort is over 13 percentage points below its peak. The latter is certainly somewhat related to young people, 18 to 24 years old, pursuing higher education at a rate of 35.6%, as opposed to 28.6% in 1991 (www.higheredinfo.com), but that rather modest difference cannot accommodate the fall off in LFPR.

The reason that LFPR is depressed among the younger and prime aged cohorts discussed above, rests with the “reservation wages” of those cohorts. A reservation wage is generally described as the lowest wage rate (although focusing on total weekly earnings, to factor in hours of work offered) at which a worker would be willing to accept a particular type of job. While this is a different amount for workers of various ages and income/wealth levels, it is obviously very much connected with the quality of jobs on offer. As the overall quality (in JQI terms) of the broad universe of jobs declines, it stands to reason that more jobs will prove unattractive (from a reservation wage (earnings) perspective) to any given age cohort of workers.

While there is a substantial amount of additional analysis required to fully address the connection between low LFPR among prime and younger cohorts, on the one hand, and JQI levels, on the other, the following two phenomena are worthy of particular comment: (i) While social security escalations (and such limited private pension arrangements as still exist), and slow to stagnant levels of median household wealth growth among Americans aged 55 and older has lagged the cost of retirement, forcing more of the population to work into their later years, and; (ii) Younger people often enjoy alternative support structures (they always have, but have been less willing to tap them in the past) from parents and can reduce their living expenses (avoiding marriage/household formation) for longer.

Thus, the reservation wages of the young and, to some extent, prime workers, are not being met by the jobs on offer, while the reservation wages of the older cohorts are relatively low and are attracting higher participation.

Unemployment benefits, disability benefits and food assistance programs also provide an obvious floor to reservation wages. It is reasonable to expect that with declining overall job quality, a larger percentage of jobs tend to bump up against this floor.

The JQI, in contrast to the balance of the universe of employment and unemployment data, may provide an effective real time readout of effective underemployment and the likelihood or absence of slack in the overall labor force.

2.3 The Relationship of the JQI to Other Endogenous and Exogenous Factors

The JQI may be expressive of trends in job formation, population and labor force demographics and labor utilization (slack or tightness). The chronology of the index over the past three decades is also illustrative of economic history during that period, insofar as that history has impacted American workers and households.

Fortuitously, the data that produce the JQI commences in the year following the two events that conveniently mark the “end date,” for all practical purposes, of both eastern and western Leninist-Maoist economies: the fall of the Berlin Wall in Europe and the Tiananmen (Liusi) Incident in China. The emergence of these post-socialist, formerly relatively closed, economies (and others, such as India and Brazil, which harbored ideological sympathies at various points) can be seen as the most significant global reorientation since World War II, especially with regard to its impact on the advanced economies of Western Europe, North America and Japan.

But while the emergence of post-socialist, large regional and national economies (with well over 40% of globe's population in the aggregate) into full-fledged competition with the traditionally capitalist, advanced nations (with just over 14% of the world's population, but over 70% of global GDP in 1990) is unquestionably the leading economic phenomenon of the present era, there were other things going on—both endogenously and exogenously—that impacted the U.S. economy and that are well reflected in the JQI.

The immediate aftermath of the events of 1989 did not see the nations of Russia (and its satellites), China, India and Brazil (later christened the BRIC nations—or BRIIC, if including Indonesia—by the economist James O'Neal in 2001) impose upon the U.S. economy and the JQI. While the early/mid 1980s saw the onslaught of imports by the U.S. from Japan, the U.S. trade balance in goods was relatively neutral as the 1990's commenced.

Rather, the 1990s featured the emergence of the so-called Asian Tiger economies, Singapore, Hong Kong, Taiwan and South Korea, following the Japanese export model and severely competing with Japan—as well as with manufacturers in the nations that were consuming those exports. The expansion of the Asian Tiger nations accelerated at an enormous clip during the 90s, and was responsible for a significant amount of outsourcing in the U.S.—and a substantial falloff in the JQI—even as the challenge they posed was destined to be surpassed by a challenge even greater than the one they posed to the U.S. (or Japan), that of the BRICs themselves. Some of the substantial falloff in the JQI was due to exogenous challenges, and some of which was due to the aftermath of the dramatic collapse in construction of real estate (particularly commercial structures) associated with the recession of 1990-91

In the meantime, while the post-socialist economies were organizing and mobilizing the political, infrastructural and financial resources that would permit their full emergence as trade competitors in the 21st century, the JQI more or less stabilized (and—just prior to the Great Recession—spiked) during the period of 1997 to 2006. This was due to two principal factors. The first, and most prominent from 1997 to 2005, was the information technology revolution (the commercial development of the internet and its application to every aspect of commerce and communications) which brought about substantial acceleration in labor productivity growth as well as employment opportunities in technology and supporting positions. That labor benefitted from the burst in what otherwise would be considered a labor-saving technological breakthrough might be a counterintuitive view. But consider that, before the internet and its myriad uses could decimate the headcount required to perform many more labor-intensive tasks, the equipment, cable, software—and the sales, transportation, marketing and support thereof—created numerous well-paid jobs and high growth in many aspects of the U.S. economy. In fact, the late 1990s was the only period to see a substantial reversal in the long-term erosion in labor's share of GDP, which has been a prominent feature of the U.S. economy from 1970 to present day.

Unfortunately, the second factor temporarily muting further erosion in the JQI during the ten years from 1997-2006 (and, for a time, even reversing it) was the meteoric rise in household debt that saw its peak period of accelerated growth from 2000-2007. The history of this period—centering around hyper-inflation of owner-occupied housing prices that resulted from, and perpetuated, a massive credit bubble—is fairly well understood. The impact of this period on the JQI is via two channels—the boom in housing construction and the employment connected therewith and the impact on consumer spending that resulted from extraordinarily high levels of household mortgage equity withdrawals in this era. Further research on the transmission of these phenomena to the JQI readings during the mid-2000s is certainly warranted.

The collapse of the housing and credit bubbles not only resulted in the Great Recession, but it revealed the impact on the U.S. employment situation of global economic imbalances and the related loss of higher quality jobs in the tradable goods sector and the many sectors that support manufacturing. With IT technology largely implemented and plateaued, with construction and finance moribund, and with the twin punches of debt deflation and global oversupply-induced disinflation yielding a tendency toward persistent secular stagnation in the U.S., the full force of globalization became firmly entrenched in the anemic U.S. economic recovery that followed the Great Recession.

The JQI fell by 13.5% from its 2006 peak to its 2012 trough and, since then, has failed to sustain a recovery to even the lowest of its levels from 1990 through 2008, save for a brief moment in the first quarter of 2017. Today, the JQI stands at only 4.3% above its all-time 2012 low and is 13.0% below its 1990 level. The index has been generally down trending since early 2017.

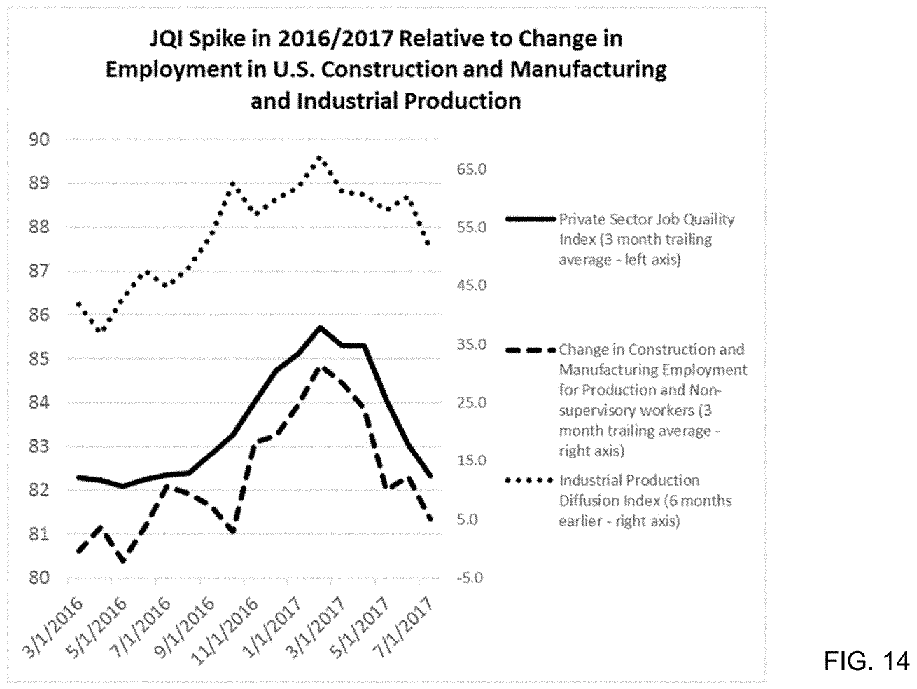

As noted above, the index peaked significantly, albeit briefly, in early 2017—with the beginning and end points of its spike running from the summer of 2016 to the summer of the following year. The move, as shown in FIG. 13 and in closer detail in FIG. 14, was substantial and defined, and coincided with an equally truncated period of growth in industrial production and related employment in the high-wage/high-hours construction and manufacturing sectors as shown in FIG. 14. The diagram illustrated in FIG. 14 may be automatically generated by the JQI system 110. Illustrated in FIG. 14 is the six-month diffusion index of the U.S. Industrial Production data (percent of the series where production increased in the indicated time span plus ½ of the percentage that were unchanged)—indexes under 50 mean more industries are producing less. Of particular interest, the period also saw substantial dollar appreciation against other currencies which ultimately limited further growth in domestic manufacturing, and which may have been responsible for the brevity of the rebound in manufacturing. This is particularly evident in the aggressive devaluation of the Euro and the Chinese RMB against the dollar from September of 2016 through the end of that year as the economies of Europe and China began to sputter.

The period also coincided with 13.4% rise in equity markets over the nine months from July 2016 through March 2017—often associated with investor confidence following the election of Donald Trump as U.S. president. But the rally was not entirely driven by the election (which was a surprise win), inasmuch as the S&P 500 had advanced from about 1,870 to about 2,120 during the eight months prior to the vote. The equity rally was likely sustained by the election results, but had its antecedent in the events illustrated in FIG. 14. The JQI's reversion, commencing in early 2017, proved to be a robust indicator of a sharp turn in industrial activity even as markets and many forecasters predicted a sustained uptick in the recovery. The continuing reversion of the index to the level prior to its upward acceleration of 2016, and its deterioration since, is notable and consistent with the failure of average incomes to rise appreciably in the years since.

Having covered economic vulnerabilities illustrated by the JQI, the answers that the index provides for several unanswered questions relating to the breakdown in the relationship between low levels of unemployment and inflation in both wages and non-asset prices, the JQI's dynamism and relation to underlying economic event.

3. Applications and Utility

3.1 The Phillip's Curve and its Descendants

One of the persistent conundrums in macroeconomics is the recent apparent disconnect in the relationship between levels of unemployment, on the one hand, and wage and price inflation, on the other. This relationship, explored by Samuelson and Solow in 1960, based on data first observed by A. William Phillips of New Zealand in 1958. The relevance of the resulting “Phillips Curve,” relating lower unemployment to higher levels of inflation (but, as Friedman et. al. demonstrated in the late-1960s, not necessarily the converse) has been batted around by economists and policy makers for decades, but remains—in various modified forms and flavors—part of central bank policy consideration to this day.

With the historically low levels of U-3 unemployment in the United States being achieved during the latter part of the 2010s, defying all earlier expectations of a natural rate of unemployment, it would have been expected to see a dramatic increase in wage inflation, and demand-pull general price inflation resulting therefrom. Yet, the relationship between unemployment and inflation has substantially eroded—beginning as early as the late-1980s.

In this century, particularly the present decade, some of the apparent disconnect is likely linked to slack in the labor force represented by lower participation rates among prime and younger workers. Lower labor force participation rates (LFPR)—and the 55 year and older civilian non-institutional population (CNIP) is excluded to avoid the impact of a clearly aging U.S. population—is evidence of an inclination of potential workers to forswear the increasing proportion of low income employment in favor of family or public support.

There is a far more substantial factor severing the earlier connections between unemployment and inflation is the changed composition of the employment base itself. The channel through which this occurs is fairly simple: If a greater proportion of jobs produce incomes below the mean of all jobs (i.e. a reduction in the level of the JQI), than they did in the past, then an increase in the proportion of people working will have a lesser impact on household incomes—and therefore aggregate demand—than in the past. The lower the increase in aggregate demand, the lower the demand-pull inflation that would result from a greater increase thereof.

The failure of recent dramatic declines in U-3 are modulated by significantly less salutary income growth.

3.2 Domestic Sovereign Interest Rates

The relative supply and demand in an economy (including internal and external sources thereof) is, notwithstanding the claims of monetarist economists to the contrary, the proximate cause of inflation and deflation. As seen in this century, while money supply can influence production and consumption, unless the supply of money transmits (in terms of both injection and velocity), relatively broadly, to primary investment and employment (or the contraction of money supply succeeds in doing the opposite), the increase or decrease in the supply of money itself will not have the impact intended by monetary policy makers.

For reasons that have been extensively researched elsewhere, that the transmission of increased money supply to aggregate demand has reached its own form of a zero lower bound over the course of the past several decades. Despite central banks in the U.S., the Eurozone, Japan and the U.K. having pumped over $10 trillion into their collective economies over the past decade, aggregate demand remains tepid and inflation, therefore, has not sustainably recovered to the target levels intended by central bankers.

With interest rates on sovereign debt issued by countries in their own currencies being, at the margin, almost entirely a function of growth- and therefore inflation-expectations for the issuing nation (on a relative basis to all other risk-free sovereign issuers), it is reasonable to look for data points that serve as modulators of transmission, or the lack thereof, of conventional metrics—such as growth or contraction of monetary policy, employment and investment—to aggregate demand, to growth, and ultimately to inflation and prevailing sovereign interest rates.

Changes in the JQI appear to be relatively well correlated to changes in market-determined (that is to say, the longer end of the yield curve, as opposed to shorter obligations that reflect monetary policy itself) U.S. sovereign interest rates both over the long term and with respect to shorter term fluctuations thereof. It is likely that the JQI, in expressing relative demand for more highly compensated workers from one moment in time to another is reflective of overall economic growth trajectories between those points. And, in some periods, it can be observed that upticks and reversals in the JQI are possibly predictive of future growth expectations and, therefore, the likely trajectory of domestic interest rates.

FIG. 9 illustrates the constant maturity yield on the 10 year U.S. Treasury bond against the JQI on a 3 month lagged basis. While not consistent with respect to the amplitude of fluctuations, there appears to be a high level of correlation in terms of directionality—especially in the second half (last 15 years) of the graph. In other words, turns in the direction of the JQI appear to be associated with turns in the direction of bond yields. This phenomenon implies a predictive use for the JQI in the financial markets and for economic policy making.

3.3 U.S. Balance of Trade in Goods and the Impact of the JQI on Household Incomes and Consumption

The decline in the JQI over the past three decades is unmistakably linked to the decline in goods producing jobs in the U.S., which fell from 25.6% to 16.4% of all private sector positions during the period. But it is also connected to the fact that nearly all of the jobs that replaced the lost goods producing positions were in traditionally low-wage/low-hours sectors.

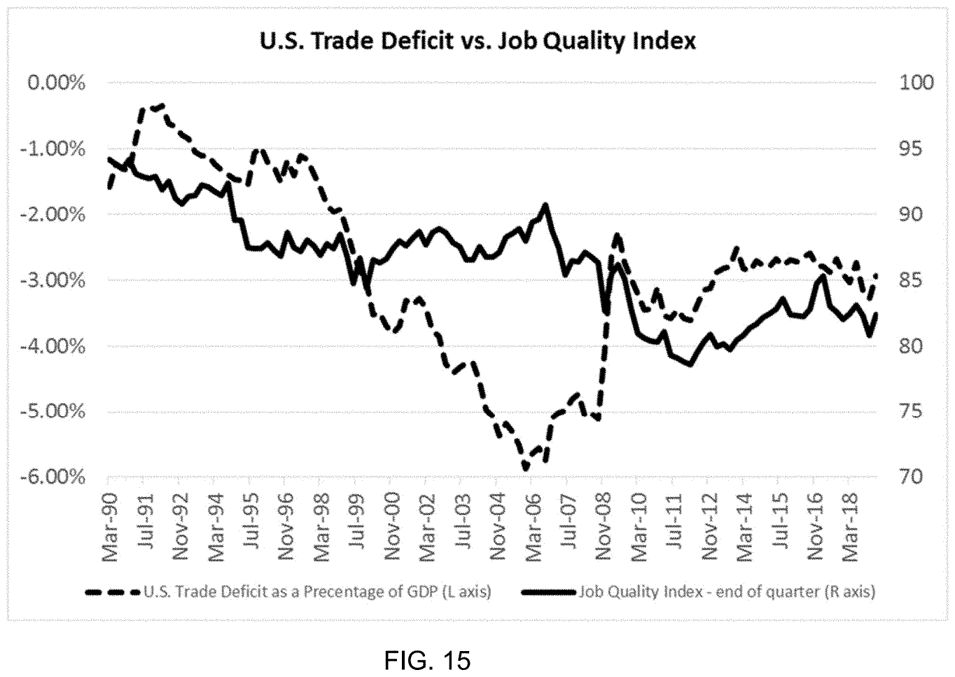

Of course, inasmuch as American consumption has continued to rise, the goods consumed had to be produced by someone—even as U.S. goods production jobs plummeted. As evidenced by U.S. balance of trade over the past several decades, goods consumed by Americans, at the margin, became increasingly to be manufactured abroad. As FIG. 15 illustrates, but for the period from 2000 until 2008, changes in the JQI tend to mirror changes in the overall U.S. trade deficit—over the medium term in the 1990s and, increasingly, on a short term basis since the Great Recession.

It should be noted that the dramatic decline of the trade deficit during the recession was not, of course, related to and improvement in the U.S. employment situation—the U.S. was bleeding millions of jobs at the time—but rather to the dramatic reduction in aggregate demand typical of a severe recession.

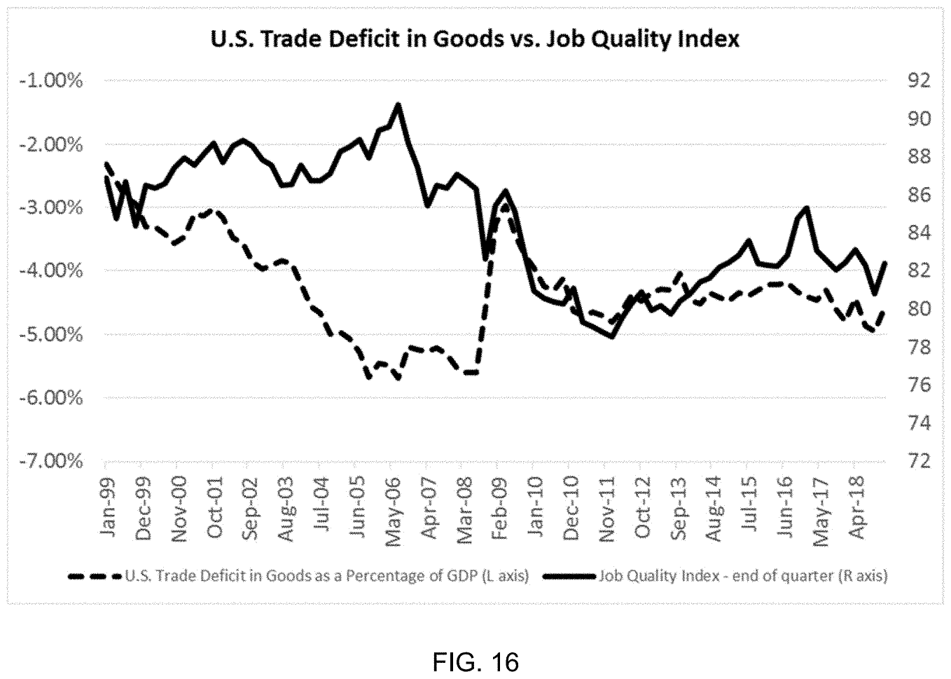

The lack of correlation between the trade balance and the JQI actually creates a “teachable moment” with respect to the function of the overall U.S. economy. It is worth remembering that—despite the erosion of the U.S. manufacturing economy that occurred in the 1990s—not only did the jobs picture stabilize (and even improve somewhat as measured by the JQI), but American consumption of goods from abroad hit a still-unexceed record as measured in terms of the trade deficit in goods-only relative to U.S. GDP, as illustrated in FIG. 16.

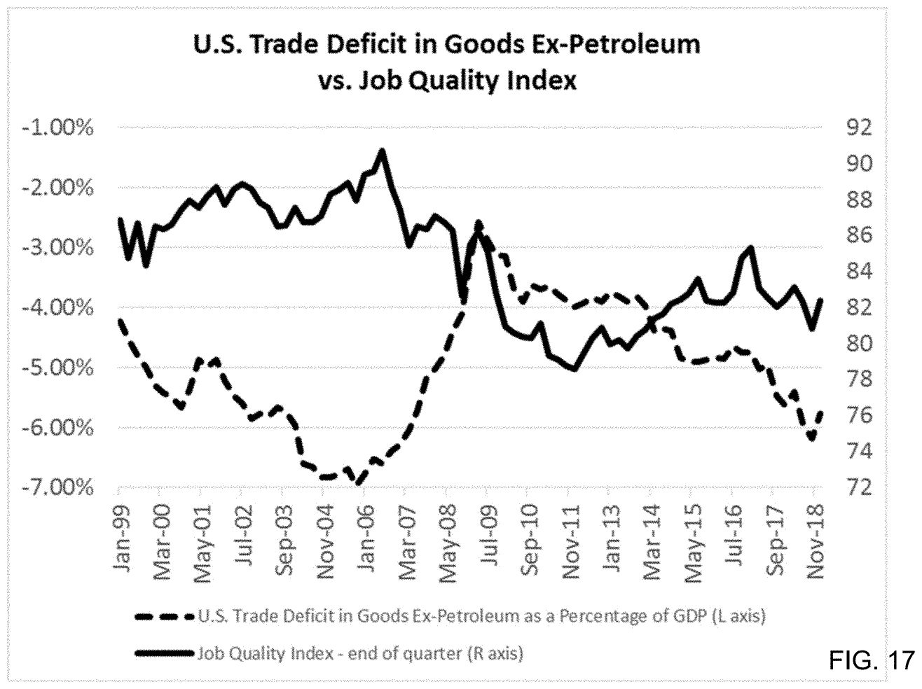

Moreover, when petroleum products are removed from the immediately foregoing analysis (the U.S. was still a substantial net importer of oil in the 2000s and is no longer so), the goods trade deficit, ex-petroleum, reveals itself as more acute and the departure of the trade deficit from the behavior of the JQI—in both the 2000s and recent years—more notable, as illustrated in FIG. 17.

Notwithstanding the slight recovery of the JQI during the periods of low U-3 unemployment, the longer term trend in the job quality mix has been declining such that the JQI in the periods following each recession since 1990 has failed to sustain a recovery to the stabilized level of the period immediately preceding it. In these periods, the additional demand generated by higher levels of employment has not channeled into investment in domestic production and the higher quality jobs that would derive therefrom. Real median household income has not advanced appreciably, and during the first decade of this century was below, the level reached at the end of the expansion of the 1990's. Overall household income has, increased more—but the gains have been concentrated in households at the very top of the wealth and income distribution, with a lower propensity to consume.

U.S. aggregate household debt rose from $6.8 trillion in December 1999, to a peak of $14.7 trillion in September 2008, an increase of 216% in less than eight years. This equated to a movement from under 70% of GDP to just a hair under 100% of GDP during that period. As that enormous increase in household debt was concentrated in the mortgage sector, fueling the high levels of mortgage equity withdrawals and, to a lesser but still very material extent, all other forms of household credit including—among other things—auto and revolving credit (credit cards) directly fueling consumption of tradable goods.

Expressed on an inflation-adjusted basis per U.S. household, the increase in household debt during the 2014-2018 period was relatively minor in comparison to the increase in same during the 2000s. Thus, the erosion in the JQI from its peak in 2016 would seem to be a greater contributor, than exploding household debt to the goods trade deficit, whereas the opposite would appear to be true during the 2000s, when the feedback loop between a true explosion in real debt per household and the U.S. employment situation actually resulted in stabilization of—and even improvement in—the JQI.

3.4 Productivity and Capacity Utilization

As more highly productive goods-producing jobs have declined over the past three decades, in favor of more, generally less productive categories of service jobs, it should be axiomatic that labor productivity gains would stall. And to a large extent, this is true.

But the decline of manufacturing in the U.S. has also likely impacted multifactor productivity gains (incorporating the productivity of capital, as well as labor) as fixed plant capacity utilization has fallen to such a degree that underutilized investments in existing capacity are acting as an encumbrance on overall productivity.

Here is an overview of multifactor productivity since 1990. The principal factor in changes to the rate of productivity gains over the past three decades was clearly the internet technology (IT) revolution, the effects of which were seen most markedly from 1996 to 2004. The relative flattening of productivity growth was certainly impacted by the Great Recession, but has continued since then, with some improvement after 2017.

Focusing further on the manufacturing sector, the post-recession decline in multifactor productivity is uncharacteristic of the two preceding cycles (the BLS did not measure the multifactor productivity prior to 1987). What is clear, however, is the overall decline in capacity utilization over 30+ and the stall in capacity utilization, after its immediate post-recession snap back, from 2012 to date.

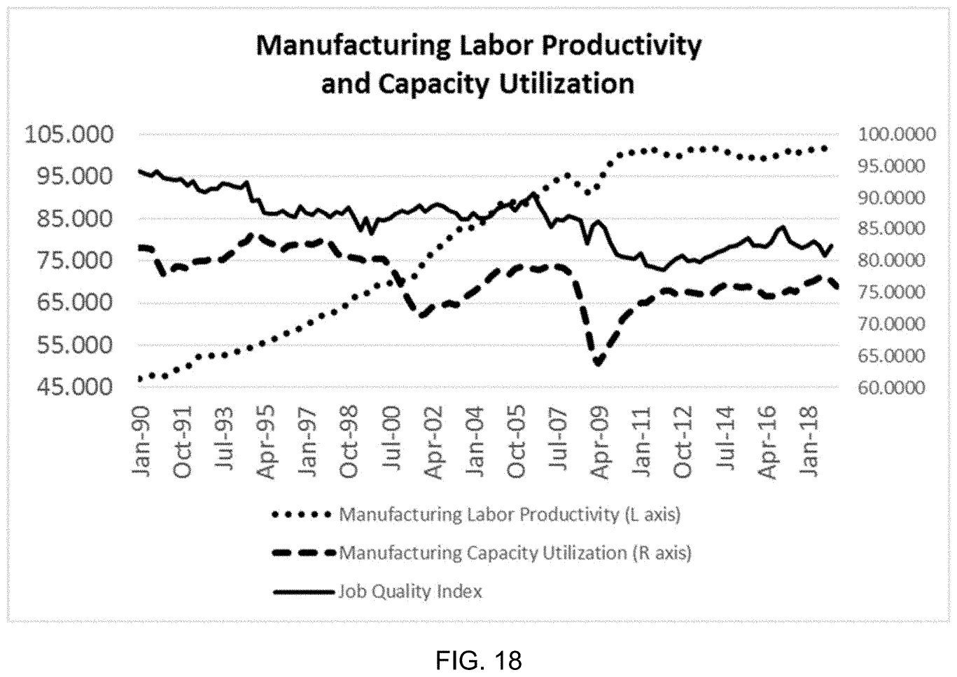

FIG. 18 provides a graph illustrating manufacturing labor productivity and capacity utilization over time.

3.5 Non-Residential Fixed Investment

The decline in U.S. job quality over the past three decades is linked substantially, although not entirely, to a decline in goods producing jobs. One factor in the economy that is highly correlated with goods producing jobs is investment in fixed assets. Clearly, residential fixed assets are a principal driver of construction jobs and—to the extent that they are not offset by imports—materials production, but with respect to manufacturing employment, the expansion thereof is highly correlated with investment in plants and equipment. Such investment also results in additional construction jobs and a broad array of generally well-paying jobs that support goods production. So it is useful, in this connection, to monitor levels of non-residential fixed investment and—for the purposes of this paper—to consider the relationship between such investment trends and the JQI.

Yet non-residential fixed investment is a broad category and incorporates assets that may or may not have a high correlation with improvement in high quality employment. For this analysis, non-residential fixed investment is separated into two categories, the first consisting of non-residential structures and (mostly) industrial equipment, and the second consisting of intellectual property assets and information processing equipment. Intellectual property investment (software, media, patentable drugs, to name a few) do have some salutary employment aspects associated with them, but the number of jobs created in the production thereof, although often well-paid, is not broad.

Information processing equipment (computing and communications for the most part) is arguably “labor-saving”—to intentionally utilize a euphemism—and may not only be imported itself, but may actually eliminate better-paid positions domestically.

The proportion of investment in intellectual property and information processing equipment, relative to total non-residential fixed investment in the U.S., has increased markedly since 1990—particularly since the Great Recession. Some of this has been due to strong end-demand for the content and products (whether or not manufactured domestically) represented by these assets, but—for the most part—the relative increase has been due to a leveling off, or contraction, of investment in non-residential structures and industrial equipment.

It is notable that real investment in non-residential structures and industrial equipment, after crashing during the recession and its aftermath, barely recovered its level of 2008 by the end of 2018—despite a 20% increase in read gross domestic production during that period. It should be further noted that the short-lived uptick in non-residential fixed asset investment in 2018, that followed the Tax Cut and Jobs Act of December 2017 was seen more in information processing equipment and intellectual property investment, on a relative basis, than in any period in history prior thereto.

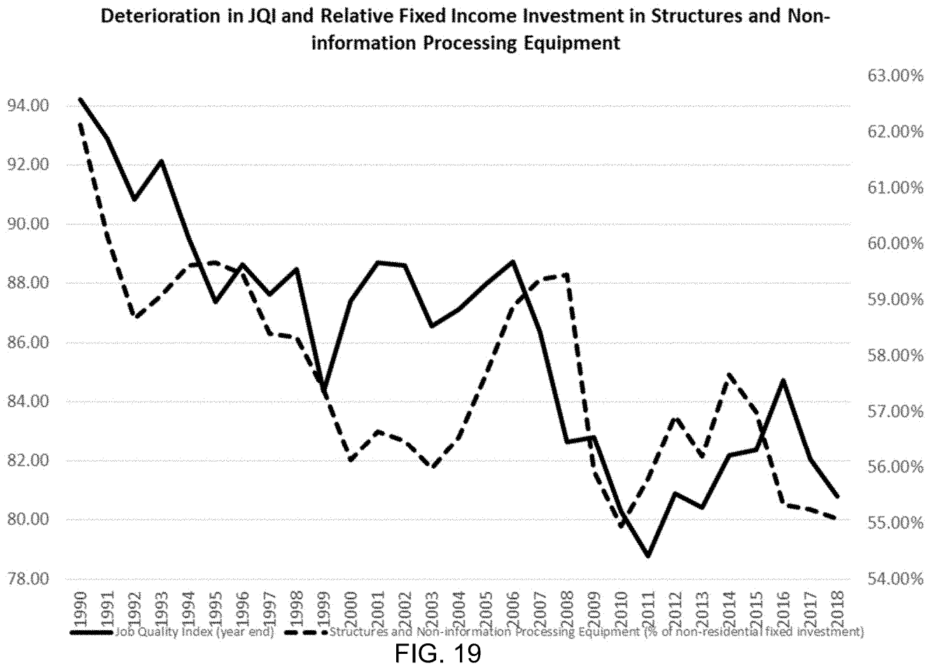

Unsurprisingly, anemic real investment in non-residential structures and industrial equipment, relative to the broader category of non-residential fixed investment in mirrored, over the medium and long term in movements of the Job Quality Index, as illustrated in FIG. 19. Further examination by market participant, economic policy makers, and the academe, of the connection between the “quality” of non-residential fixed investment, in terms of its impact on higher wage/higher hours employment thus appears warranted. Over time, the processor 130 may refine elements of the JQI to enable more precise views of these connections within specific industrial groups.

The twin “demons” of economic analysis are causality and correlation. There is always a temptation to highlight relationships that appear to be noteworthy—and are in fact correlative during certain periods. But the difficulty comes in teasing apart from such correlations the factors that are truly causal. The intermediary between the two rests in the “reliability” of the transmission from one factor to another.

The relationships between the JQI and the various other factors discussed here run the gamut from causality to correlation. In some instances, deteriorating job quality in the U.S. is reflective of exogenous factors—such as the mass of inexpensive global labor and the persistently strong dollar that makes imports to the U.S. cheap and its exports expensive for foreigners. In others, the poor domestic job quality is itself responsible stagnation of domestic household incomes, demand, and—ultimately—growth, despite the recovery (or even historic lows) in unemployment and generally steady job formation. And there are, of course, derivatives that can be tied to changes in job quality, such as inflation and prevailing domestic interest rates.

This connectivity, be it causal or merely correlative, requires close examination and testing of transmission mechanics to put chicken and egg in correct order. JQI may fill in a critical (and heretofore generally absent) piece of the economic puzzle. The processor 130 may monitor JQI's periodic advances and rollovers as a forecasting tool and to using the index in combination with other indicators to better explain the failure of certain factors—that have traditionally been viewed as directly having influence on one another—to perform as expected.

The system or the processor disclosed herein may generate sectoral sub-indices for U.S. industry super-sectors or sectors, as shown in the table below.

| Sector | Size in thousands |
|---|---|
| Construction | 7,646 |
| Manufacturing | 12,861 |
| Trade, transportation and Utilities | 27,825 |
| Financial activities | 8,850 |
| Professional, technical and mgmt. | 12,164 |
| Administrative and waste | 9,404 |
| Healthcare and social assistance | 20,753 |
| Leisure and hospitality | 16,873 |

The system or the processor disclosed herein may generate large state sub-indices for states such as California, Texas, Florida and New York. Further, the system or the processor disclosed herein may generate regional sub-indices for regions such as New England, Mid-Atlantic (ex-NY), Southeast (ex-FL), Midwest (ex-TX), and Mountain and Pacific (ex-CA).

Further, the system or the processor disclosed herein may perform detailed correlation analysis covering the following aspects. First, the processor may perform correlation analysis regarding the economic data as being correlative with the JQI. Second, the processor may perform correlations of the industrial sub-indices with market behavior of comparable sectoral ETFs and other tradable instruments. Further, the processor may perform derivative analysis of the degree to which margins in various industries are dependent (or not) on an elastic pool of low-wage or low-hour labor. The processor may tie together the JQI's findings with the issue of increasing capital share of production and—therefore—the vulnerability of certain domestic industries to demographic changes, political changes (e.g. immigration restrictions) and reservation wage issues.

The system or the processor disclosed herein may develop a JQI-2, which may expand the JQI analysis to cover all U.S. jobs—as opposed to the production and non-supervisory jobs (about 83% of all jobs) covered by the existing JQI. The dataset for JQI-2 may begin in 2000, while the JQI dataset may begin in 1990, as granular data on all employees has only been available since 2000.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for generating a job quality index (JQI) that represents quality of U.S. jobs, comprising:
a non-transitory computer readable medium; and
a processor configured to:
send a query, over a network, to a remote data server to retrieve monthly current employment survey (CES) data;
store the retrieved CES data in the non-transitory computer readable medium;
calculate a high-quality benchmark by calculating a weighted average in weekly wages for each of a plurality of industries based on the CES data;
determine a first total count of high-quality jobs and a first total count of low-quality jobs based on a comparison between an average weekly wage of each industry and the high-quality benchmark;
calculate a preliminary JQI by dividing the first total count of high-quality jobs by the first total count of low-quality jobs; and
output for display, over the network, on a user device, the calculated preliminary JQI.

2. The system of claim 1, wherein the processor adjusts the high-quality benchmark on a monthly basis based on monthly CES data retrieved from the remote data server.

3. The system of claim 2, wherein the processor compares a weekly wage of each industry for a month to the adjusted high-quality benchmark for the month to determine whether the industry's jobs are high or low quality.

4. The system of claim 3, wherein the processor determines that an industry's jobs are low quality when the industry's weekly wage for the month is below the adjusted high-quality benchmark for the month.

5. The system of claim 3, wherein the processor determines that an industry's jobs are high quality when the industry's weekly wage for the month is above the adjusted high-quality benchmark for the month.

6. The system of claim 1, wherein the remote data server is a data server provided by the U.S. Bureau of Labor Statistics.

7. The system of claim 1, wherein the processor is configured to:
send a query to the remote data server to retrieve an annual National Compensation Survey (NCS); and
recalculate the preliminary JQI to incorporate annual changes in subsector wage cohorts reported in the NCS.

8. The system of claim 1, wherein the processor is configured to:
send a query to the remote data server to retrieve annual occupational employment statistics survey data; and
filter the annual occupational employment statistics survey data to only include major occupations within each industry.

9. The system of claim 8, wherein the processor is configured to:
identify a flip category of industries from the filtered annual occupational employment statistics survey data, wherein each industry in the flip category has a high propensity of flipping above and below the high-quality benchmark, and wherein each industry in the flip category has at least one million employees;
collect annual wage data from the filtered annual occupational employment statistics survey data for each occupation in the flip category; and
convert the collected annual wage data into weekly wage for each occupation.

10. The system of claim 9, wherein the processor is configured to:
calculate a second high-quality benchmark by determining a monthly average of the high-quality benchmark of twelve months;
compare the converted weekly wage to the second high-quality benchmark; and
determine a second total count of high-quality jobs and a second total count of low-quality jobs within the flip category based on a comparison between the converted weekly wage and the high-quality benchmark.

11. The system of claim 10, wherein the processor is configured to:
calculate a percentage of high-quality jobs for each flip category by dividing the second total count of high-quality jobs by a total number of jobs;
multiply the calculated percentage of high-quality by employment data provided by the CES data for each flip category; and
sort employment numbers for each flip industry found in the CES into high or low quality.

12. The system of claim 11, wherein the processor is configured to:
for each flip category, use the percentage of high-quality jobs to adjust the preliminary JQI to derive an adjusted JQI; and
output for display, over the network, on the user device, the calculated adjusted JQI.

13. A system for generating a job quality index (JQI) that represents quality of U.S. jobs, comprising:
a non-transitory computer readable medium; and
a processor configured to:
send a first query, in real time, over a network, to a remote data server to retrieve monthly current employment survey (CES) data;
calculate a high-quality benchmark by calculating a weighted average in weekly wages for each of a plurality of industries based on the CES data;
determine a first total count of high-quality jobs and a first total count of low-quality jobs based on a comparison between an average weekly wage of each industry and the high-quality benchmark;
calculate a preliminary JQI by dividing the first total count of high-quality jobs by the first total count of low-quality jobs;
send a second query, in real time, to the remote data server to retrieve annual occupational employment statistics survey data;
filter the annual occupational employment statistics survey data to include major occupations within each industry;
identify a flip category of industries from the filtered annual occupational employment statistic survey data, wherein each industry in the flip category has a high propensity of flipping above and below the high-quality benchmark, and wherein each industry in the flip category has at least one million employees;
collect annual wage data from the filtered annual occupational employment statistics survey data for each occupation in the flip category;
convert the collected annual wage data into weekly wage for each occupation.
calculate a second high-quality benchmark by determining a monthly average of the high-quality benchmark of twelve months;
compare the converted weekly wage to the second high-quality benchmark;
determine a second total count of high-quality jobs and a second total count of low-quality jobs within the flip category based on a comparison between the converted weekly wage and the high-quality benchmark;
calculate a percentage of high-quality jobs for each flip category by dividing the second total count of high-quality jobs by a total number of jobs;
multiply the calculated percentage of high-quality by employment data provided by the CES data for each flip category to determine a third total count of high-quality jobs;
determine a third total count of low-quality jobs based on the employment data provided by the CES data for each flip category and the third total count of high-quality jobs;
for each flip category, adjust the preliminary JQI based on the third total count of high-quality jobs and the third total count of high-quality jobs to derive an adjusted JQI; and
automatically transmit, over the network, to the user device, the calculated adjusted JQI.

14. The system of claim 11, wherein the processor compares the calculated adjusted JQI to a predetermined threshold, automatically generates an alert based on a comparison between the calculated adjusted JQI and the predetermined threshold, and transmits the generated alert to the user device.

15. The system of claim 11, wherein the processor determines a moving average of the calculated adjusted JQI over a predetermined period of time.

16. The system of claim 15, wherein the processor identifies a correlation between the determined moving average and financial data provided by an external database, and generates an alert to the user device reporting the identified correlation.

17. The system of claim 15, wherein the processor detects a change of the determined moving average of the calculated adjusted JQI, and automatically generates an alert to the user device reporting the detected change, wherein the detected change meets a trigger threshold.

18. The system of claim 15, wherein the processor automatically generates a diagram illustrating the calculated adjusted JQI relative to financial data provided by an external database.

19. The system of claim 15, wherein the processor automatically transmits the calculated adjusted JQI to a trading platform of futures market to price securities and permit trading.
